(19) United States
(12) Patent Application Publication
(10) Pub. No.: US 2017/0262527 A1
(43) Pub. Date: Sep. 14, 2017

(54) SEARCH APPARATUS AND RECORDING MEDIUM

(71) Applicant: Konica Minolta, Inc., Tokyo (JP)

(72) Inventor: Koji SATO, Itami-shi (JP)

(73) Assignee: Konica Minolta, Inc., Tokyo (JP)

(21) Appl. No.: 15/453,122

(22) Filed: Mar. 8, 2017

(30) Foreign Application Priority Data
Mar. 14, 2016 (JP) 2016-049630

(51) Int. Cl. G06F 17/30; G06F 17/21

(52) U.S. Cl. CPC G06F 17/30675; G06F 17/214; G06F 17/30696; G06F 17/30864

(57) ABSTRACT

A search apparatus for performing a keyword search in one or more electronic documents includes a receiving part for receiving a specification input regarding a keyword to be searched for, a search part for performing a keyword search based on the specification input, an acquisition part for acquiring an index value based on a contrast between the total number of characters in a unit region including a specific text object retrieved by the keyword search and the number of characters of one or more text objects in the unit region, which have the same attribute as that of the specific text object, the index value indicating the rarity of the attribute of the specific text object, and a determination part for determining a degree of significance of the specific text object on the basis of the index value.

The present U.S. patent application claims a priority under the Paris Convention of Japanese patent application No. 2016-049630 filed on Mar. 14, 2016, the entirety of which is incorporated herein by references.

### BACKGROUND OF THE INVENTION

Field of the Invention

The present invention relates to a technique for performing a keyword search by a search apparatus (computer or the like), and its relevant technique.

Description of the Background Art

In a search apparatus such as a computer or the like, there has been a technique for performing a keyword search in an electronic document (see Japanese Patent Application Laid Open Gazette No. 2007-241482 (Patent Document 1) and the like).

In a case where text objects (character strings) coincident with a search keyword are extracted, however, when the text objects which are search results are simply listed in disorder, a user is sometimes forced to access a number of unhelpful information. Since not only significant information but also insignificant information is included in the extracted information (text objects), the number of accesses to insignificant information (in other words, accesses to unhelpful information) sometimes increases.

In order to facilitate the access to significant information, for example, it is preferable that the degree of significance of each text object (character string) extracted from an electronic document to be searched should be taken into consideration.

As described later, however, it is not easy to appropriately determine the degree of significance of each text object extracted from the electronic document.

### SUMMARY OF THE INVENTION

It is an object of the present invention to provide a technique for appropriately determining a degree of significance of a character string retrieved by a keyword search.

The present invention is intended for a search apparatus for performing a keyword search in one or more electronic documents. According to a first aspect of the present invention, the search apparatus includes a receiving part for receiving a specification input regarding a keyword to be searched for, a search part for performing a keyword search based on the specification input, an acquisition part for acquiring an index value based on a contrast between the total number of characters in a unit region including a specific text object retrieved by the keyword search and the number of characters of one or more text objects in the unit region, which have the same attribute as that of the specific text object, the index value indicating the rarity of the attribute of the specific text object, and a determination part for determining a degree of significance of the specific text object on the basis of the index value.

The present invention is also intended for a non-transitory computer-readable recording medium. According to a second aspect of the present invention, the non-transitory computer-readable recording medium records therein a computer program to be executed by a computer to cause the computer to perform the steps of a) receiving a specification input regarding a keyword to be searched for, b) performing a keyword search in one or more electronic documents on the basis of the specification input, c) acquiring an index value based on a contrast between the total number of characters in a unit region including a specific text object retrieved by the keyword search and the number of characters of one or more text objects in the unit region, which have the same attribute as that of the specific text object, the index value indicating the rarity of the attribute of the specific text object, and d) determining a degree of significance of the specific text object on the basis of the index value.

According to a third aspect of the present invention, the non-transitory computer-readable recording medium records therein a computer program to be executed by a computer to cause the computer to perform the steps of a) generating attribute information defining the total number of characters in a unit region in an electronic document and the number of characters for each attribute in the unit region and b) transmitting the attribute information to a search apparatus for performing a keyword search or an apparatus under the control of the search apparatus.

According to a fourth aspect of the present invention, the non-transitory computer-readable recording medium records therein a computer program to be executed by a computer to cause the computer to perform the steps of a) receiving attribute information defining the total number of characters in a unit region in each electronic document and the number of characters for each attribute in the unit region from a generation apparatus for each electronic document, b) receiving a specification input regarding a keyword to be searched for, c) performing a keyword search in each electronic document on the basis of the specification input, d) specifying one attribute which is the same attribute as that of a specific text object retrieved by the keyword search, e) calculating an index value based on a contrast between the total number of characters in a unit region including the specific text object and the number of characters of one or more text objects in the unit region, which have the one attribute, the index value indicating the rarity of the attribute of the specific text object, on the basis of the attribute information, and f) determining a degree of significance of the specific text object on the basis of the index value.

According to a fifth aspect of the present invention, the search apparatus includes a receiving part for receiving a specification input regarding a keyword to be searched for, a search part for performing a keyword search based on the specification input, an acquisition part for acquiring an index value based on a contrast between the total number of words in a unit region including a specific text object retrieved by the keyword search and the number of words of one or more text objects in the unit region, which have the same attribute as that of the specific text object, the index value indicating the rarity of the attribute of the specific text object, and a determination part for determining a degree of significance of the specific text object on the basis of the index value.

According to a sixth aspect of the present invention, the non-transitory computer-readable recording medium records therein a computer program to be executed by a computer to cause the computer to perform the steps of a) receiving a specification input regarding a keyword to be searched for, b) performing a keyword search in one or more electronic documents on the basis of the specification input, c) acquiring an index value based on a contrast between the total number of words in a unit region including a specific text object retrieved by the keyword search and the number of words of one or more text objects in the unit region, which have the same attribute as that of the specific text object, the index value indicating the rarity of the attribute of the specific text object, and d) determining a degree of significance of the specific text object on the basis of the index value.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing an overall configuration of a search system;

FIG. 2 is a schematic diagram showing a constitution of an MFP;

FIG. 3 is a diagram showing a schematic constitution of a print instruction apparatus (document generation apparatus);

FIG. 4 is a diagram showing a schematic constitution of a search instruction apparatus;

FIG. 5 is a diagram showing a schematic constitution of a server (search apparatus);

FIG. 6 is a view showing an overview of an operation (document accumulation operation and the like) in the search system;

FIG. 7 is a view showing an overview of an operation (search operation and the like) in the search system;

FIG. 8 is a flowchart showing an operation of a server;

FIG. 9 is a view showing a search screen;

FIG. 10 is a view showing a first document from which a search keyword is extracted;

FIG. 11 is a view showing a second document from which the search keyword is extracted;

FIG. 12 is a view showing a first page of the first document;

FIGS. 13 and 14 are views each showing an index value and the like of an extracted character string;

FIG. 15 is a view showing a second page of the first document;

FIG. 16 is a view showing an index value and the like of an extracted character string;

FIG. 17 is a view showing a first page of the second document;

FIGS. 18 to 20 are views each showing an index value and the like of an extracted character string;

FIG. 21 is a view showing a second page of the second document;

FIG. 22 is a view showing an index value and the like of an extracted character string;

FIG. 23 is a view collectively showing respective index values and the like of a plurality of character strings;

FIG. 24 is a view showing a calculation result of a degree of significance of each page;

FIG. 25 is a view showing an exemplary display of a search result list (in a unit of a page);

FIG. 26 is a view showing a display screen of a corresponding page;

FIG. 27 is a view showing a search result list (in a unit of a document) in accordance with a second preferred embodiment;

FIG. 28 is a view showing an operation (document accumulation operation and the like) in accordance with a third preferred embodiment;

FIG. 29 is a view showing an operation (PDL data analysis operation and the like) in accordance with a fourth preferred embodiment;

FIG. 30 is a view showing attribute information obtained in an analysis process;

FIG. 31 is a view showing an operation (document data analysis operation and the like) in accordance with a fifth preferred embodiment;

FIG. 32 is a view showing a thumbnail display (in a sixth preferred embodiment);

FIGS. 33 to 37 are views each showing an index value and the like calculated in an eighth preferred embodiment;

FIG. 38 is a view collectively showing respective index values and the like of a plurality of character strings (in the eighth preferred embodiment); and

FIG. 39 is a view collectively showing respective index values and the like of a plurality of character strings (in a ninth preferred embodiment).

### DESCRIPTION OF THE PREFERRED EMBODIMENTS

Hereinafter, an embodiment of the present invention will be described with reference to the drawings. However, the scope of the invention is not limited to the illustrated examples.

### 1. The First Preferred Embodiment

<1-1. Overall Constitution of System>

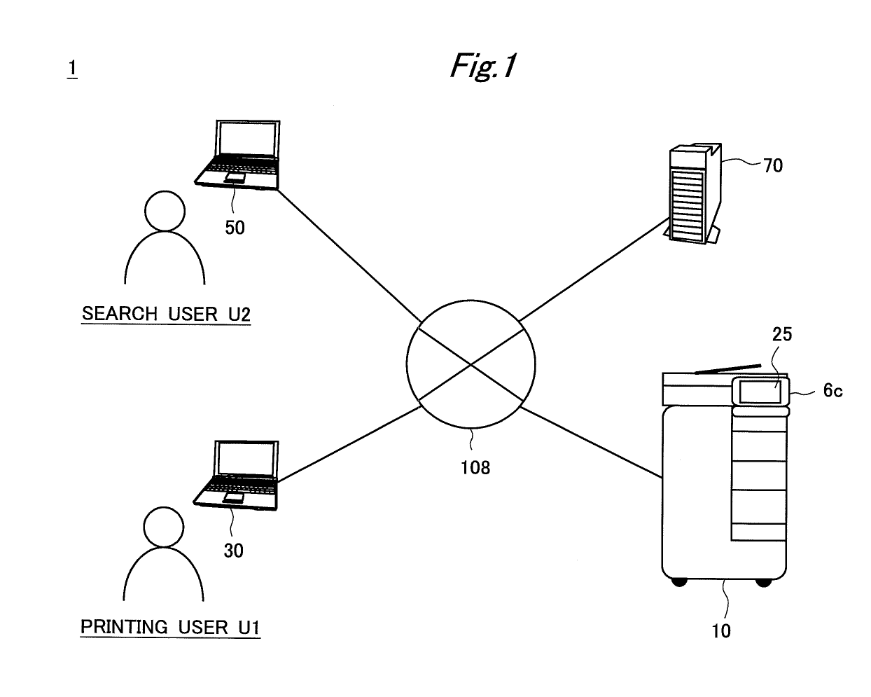

FIG. 1 is a view showing an overall configuration of a search system 1.

As shown in FIG. 1, the search system 1 comprises an MFP 10, a server computer (hereinafter, also referred to simply as a server) 70, a client computer for printing (hereinafter, also referred to simply as a client) 30, and a client 50 for document search. Further, the client 30 is also referred to as a print instruction apparatus, the server 70 is also referred to as a search apparatus, and the client 50 is also referred to as a search instruction apparatus.

The constituent elements 10, 30, 50, and 70 are connected with one another through a network 108, and capable of performing network communication with one another. Further, the network 108 includes a LAN (Local Area Network) 107, the internet, and the like. The connection between each of the constituent elements and the network 108 may be a wired connection or a wireless connection.

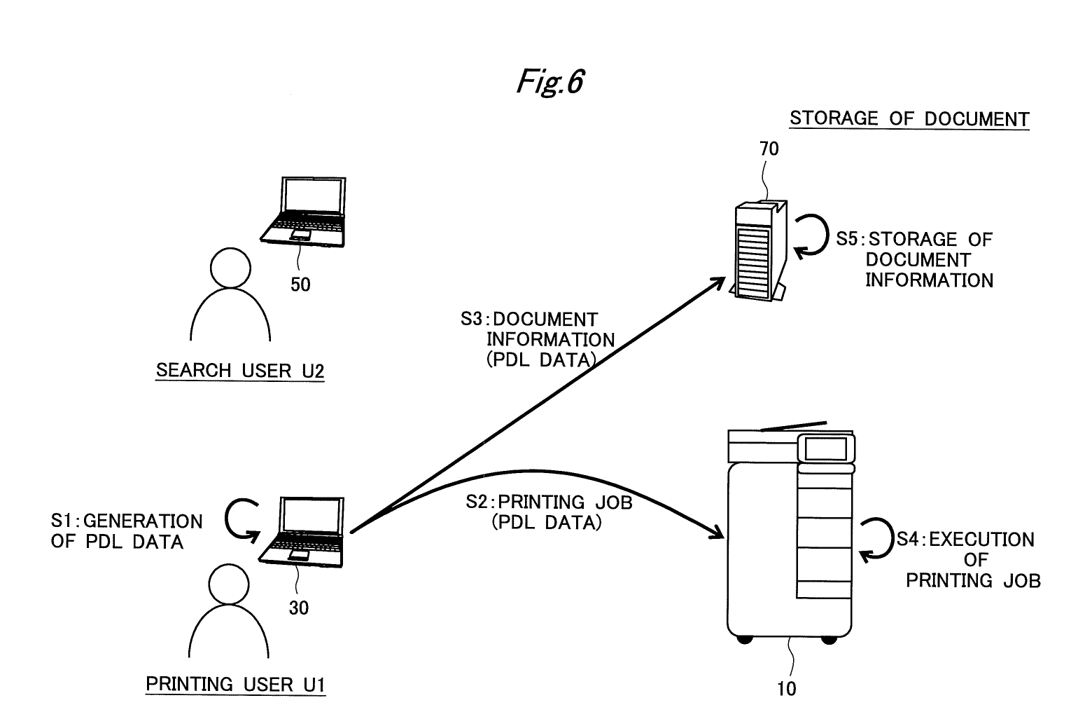

In this search system 1, the client (print instruction apparatus) 30 generates print data for a document to be printed (PDL data (data described by a page description language)) in accordance with a print instruction operation by a printing user (U1 or the like) (also see Step S1 of FIG. 6). Then, the client 30 transmits the print data to the MFP 10 (Step S2) and also transmits the print data to the server 70 (Step S3). When the MFP 10 receives the print data, the MFP 10 performs a printing operation on the basis of the print data (Step S4). Further, the server 70 stores therein the print data (Step S5). The print data is data including a text object and also referred to as an electronic document.

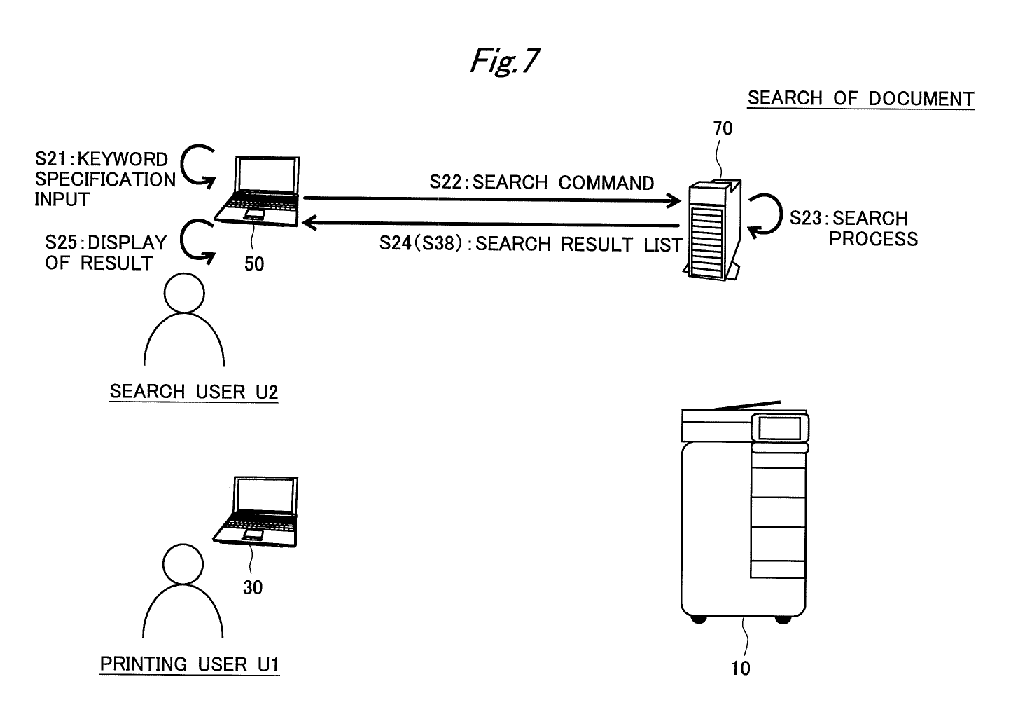

When the client (search instruction apparatus) 50 receives a keyword search instruction (instruction to perform a keyword search) from a search user (U2 or the like) in accordance with a search operation (also see Step S21 of FIG. 7) by the search user, the client 50 transfers the keyword search instruction to the server 70 (Step S22). In accordance with the keyword search instruction, the server 70 searches the electronic document stored in the server 70 for a text object regarding a keyword specified by the user (Step S23). The server 70 transmits a result of the search process (search result) to the client (computer for document search) 50 (Step S24), and the client 50 displays thereon the received search result (Step S25). The search user can thereby visually recognize the search result.

<1-2. MFP 10>

Next, the MFP (Multi-Functional Peripheral) 10 will be described.

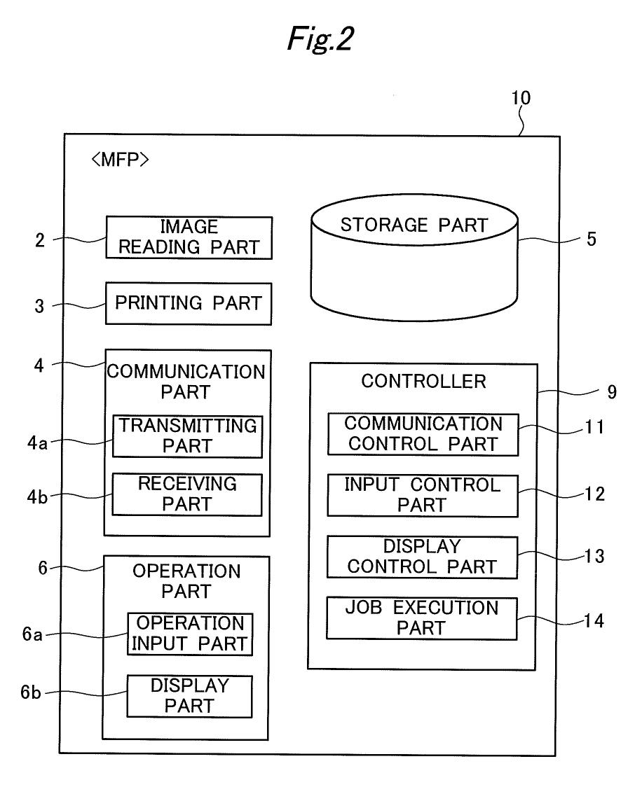

FIG. 2 is a schematic diagram showing a constitution of the MFP. The MFP is an apparatus (also referred to as a multifunction machine) having a scanner function, a printing function, a copy function, a data communication function, and the like.

The MFP is an image forming apparatus which is capable of performing a printing operation, an image reading operation (scanning operation), and the like.

As shown in FIG. 2, the MFP comprises an image reading part 2, a printing part 3, a communication part 4, a storage part 5, an input/output part 6, a controller 9, and the like, and multiply uses these constituent parts to implement various functions.

The image reading part 2 is a processing part which optically reads an original manuscript placed on a predetermined position of the MFP and generates image data of the original manuscript (also referred to as an “original manuscript image”).

The printing part 3 is an output part which prints out an image to various media such as paper on the basis of the image data on an object to be printed.

The communication part 4 is a processing part capable of performing facsimile communication via public networks or the like. Further, the communication part 4 is capable of performing network communication via the network 108. The network communication uses various communication protocols such as TCP (Transmission Control Protocol), IP (Internet Protocol), FTP (File Transfer Protocol), and the like. By using the network communication, the MFP can transmit and receive various data to/from desired partners (the client 30 and the like).

The storage part 5 is a storage unit such as a hard disk drive (HDD), a nonvolatile memory, or/and the like.

The input/output part 6 comprises an operation input part 6a for receiving an input which is given to the MFP and a display part 6b for displaying various information thereon. The input/output part 6 is also referred to as an operation part.

The controller 9 is a control part for generally controlling the MFP, and comprises a CPU and various semiconductor memories (RAM, ROM, and the like).

The controller 9 causes the CPU to execute a predetermined software program (also referred to simply as a “program”) stored in the ROM (e.g., EEPROM (registered trademark) or the like), to thereby implement various processing parts. The various processing parts include a communication control part 11, an input control part 12, a display control part 13, a job execution part 14 for performing various jobs, and the like. Further, the program may be recorded in one of various portable recording media such as a USB memory and the like (in other words, various non-transitory computer-readable recording media), and read out from the recording medium to be installed in the MFP. Alternatively, the program may be downloaded via the network or the like to be installed in the MFP.

<1-3. Client (Print Instruction Apparatus) 30>

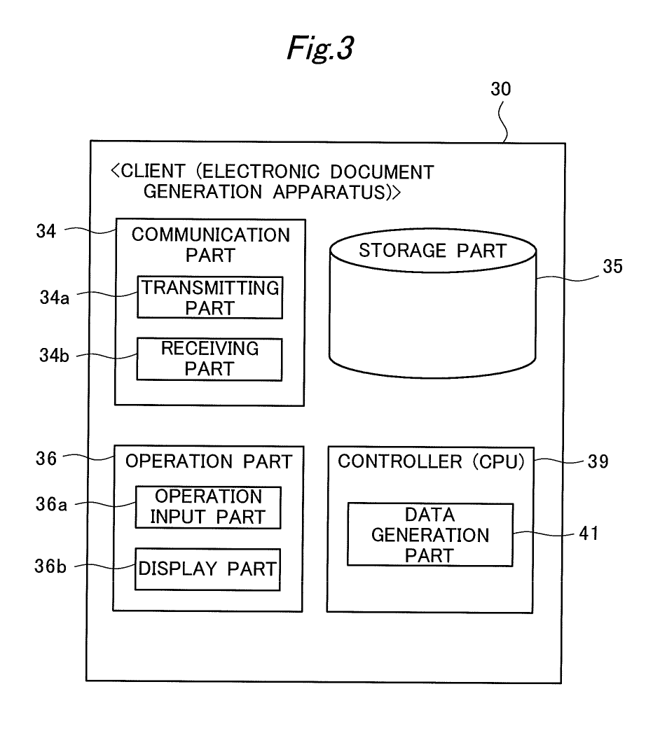

FIG. 3 is a diagram showing a schematic constitution of the client 30. The client 30 is constructed by using a personal computer or the like.

The client 30 comprises a communication part 34, a storage part 35, an operation part 36, a controller (CPU) 39, and the like.

The communication part 34 is capable of performing network communication via the network 108. The network communication uses various communication protocols such as TCP/IP (Transmission Control Protocol/Internet Protocol) and the like. By using the network communication, the client 30 can transmit and receive various data to/from desired partners (the MFP 10, the server 70, and the like). The communication part 34 has a transmitting part 34a for transmitting various data and a receiving part 34b for receiving various data. For example, the transmitting part 34a transmits the print data to the MFP 10 and the server 70.

The storage part 35 is a storage unit such as a nonvolatile semiconductor memory, or/and the like.

The operation part 36 comprises an operation input part 36a for receiving an input which is given to the client 30 and a display part 36b for displaying various information thereon.

The client 30 causes the CPU (controller) 39 to execute a predetermined program stored in the storage part 35, to thereby implement various processing parts. The program may be recorded in one of various portable recording media such as a USB memory and the like (in other words, various non-transitory computer-readable recording media), and read out from the recording medium to be installed in the client 30. Alternatively, the program may be downloaded via the network or the like to be installed in the client 30.

Specifically, the CPU 39 of the client 30 executes the program (for example, a printer driver), to thereby implement various processing parts including a data generation part 41 and the like. The data generation part 41 generates, for example, the print data (PDL data) or the like. Further, as discussed later, the print data which are generated by the client 30 and accumulated in the server 70 are dealt as electronic documents to be searched. Since the client 30 generates an electronic document (PDL data) in accordance with a print instruction, the client 30 is also referred to as an electronic document generation apparatus.

<1-4. Client (Search Instruction Apparatus) 50>

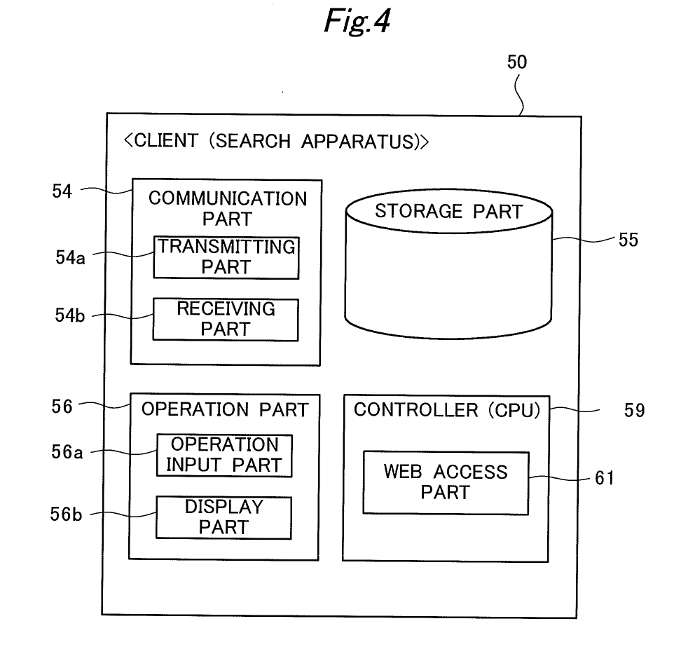

FIG. 4 is a diagram showing a schematic constitution of the client 50. The client 50 is also constructed by using a personal computer or the like.

The client 50 comprises a communication part 54, a storage part 55, an operation part 56, a controller (CPU) 59, and the like.

The communication part 54 is capable of performing network communication via the network 108. The network communication uses various communication protocols such as TCP/IP (Transmission Control Protocol/Internet Protocol) and the like. By using the network communication, the client 50 can transmit and receive various data to/from desired partners (the server 70 and the like). The communication part 54 has a transmitting part 54a for transmitting various data and a receiving part 54b for receiving various data. For example, the transmitting part 54a transmits information such as a search keyword specified by the user, and the like, to the server 70. Further, the receiving part 54b receives a search result of a keyword search from the server 70.

The storage part 55 is a storage unit such as a nonvolatile semiconductor memory, or/and the like.

The operation part 56 comprises an operation input part 56a for receiving an input which is given to the client 50 and a display part 56b for displaying various information thereon.

The client 50 causes the CPU (controller) 59 to execute a predetermined program stored in the storage part 55, to thereby implement various processing parts. The program may be recorded in one of various portable recording media such as a USB memory and the like (in other words, various non-transitory computer-readable recording media), and read out from the recording medium to be installed in the client 50. Alternatively, the program may be downloaded via the network or the like to be installed in the client 50.

Specifically, the CPU 59 of the client 50 executes the program (for example, a web browser), to thereby implement various processing parts including a web access part 61 and the like. The web access part 61 controls, for example, an operation of accessing the server (web server) 70 to acquire information on a search screen and display the information on the client 50. Further, the web access part 61 receives a user instruction (keyword specification input or the like) given to an input screen (search screen) displayed on the web browser and transmits the user instruction to the server 70.

<1-5. Server (Search Apparatus) 70>

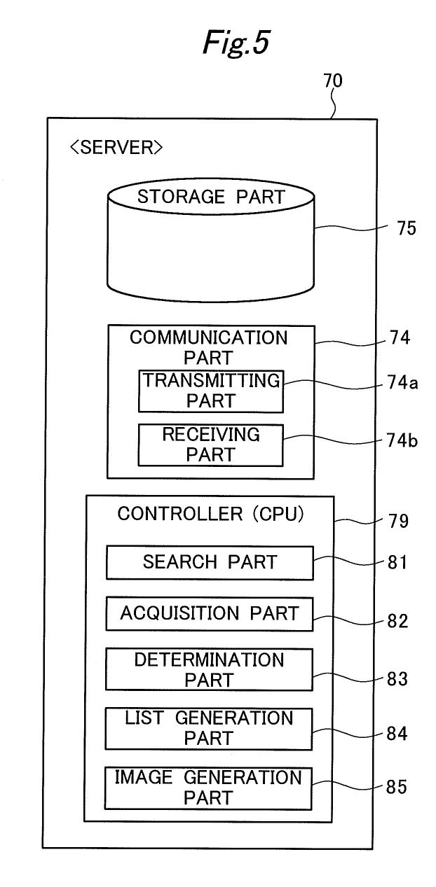

FIG. 5 is a diagram showing a schematic constitution of the server 70. The server 70 is constructed by using a server computer, a personal computer, or the like.

The server 70 comprises a communication part 74, a storage part 75, a controller (CPU) 79, and the like.

The communication part 74 is capable of performing network communication via the network 108. The network communication uses various communication protocols such as TCP/IP (Transmission Control Protocol/Internet Protocol) and the like. By using the network communication, the server 70 can transmit and receive various data to/from desired partners (the clients 30 and 50 and the like). The communication part 74 has a transmitting part 74a for transmitting various data and a receiving part 74b for receiving various data. For example, the receiving part 74b receives a specification input regarding a keyword to be searched for, from the client 50. Further, the transmitting part 74a transmits a search result of a keyword search to the client 50.

The storage part 75 is a storage unit such as a nonvolatile semiconductor memory, or/and the like. The storage part 75 stores therein, for example, the electronic documents (PDL data or the like) transmitted from the client 30.

The server 70 causes the CPU (controller) 79 to execute a predetermined program stored in the storage part 75, to thereby implement various processing parts. The program may be recorded in one of various portable recording media such as a USB memory and the like (in other words, various non-transitory computer-readable recording media), and read out from the recording medium to be installed in the server 70. Alternatively, the program may be downloaded via the network or the like to be installed in the server 70.

Specifically, the CPU 79 of the server 70 executes the program (search application or the like), to thereby implement various processing parts including a search part 81, an acquisition part (index value calculation part) 82, a determination part 83, a list generation part 84, and an image generation part 85.

The search part 81 is a processing part for performing a keyword search (search process) based on the specification input by the user.

The acquisition part 82 is a processing part for acquiring (in detail, calculating) an index value (described later) indicating the rarity of an attribute of a text object.

The determination part 83 is a processing part for determining a degree of significance of each text object on the basis of the index value.

The list generation part 84 is a processing part for generating a search result list described later. For example, the list generation part 84 generates a list in which pages including at least one text object retrieved by the keyword search from one or more electronic documents are arranged in accordance with the degree of significance of each page.

The image generation part 85 is a processing part for generating a page image or the like including the keyword which is searched for. For example, when a display instruction of a specific page is given by the user who consults the list, the image generation part 85 generates a thumbnail image including the specific page in response to the display instruction.

<1-6. Overall Operation>

FIGS. 6 and 7 are views each showing an overview of an operation in the search system 1.

In the search system 1, as described above, the PDL data (electronic document) is transmitted from the client (print instruction apparatus) 30 to the server 70 in accordance with the printing operation to be performed by the printing user U1, and the PDL data (electronic document) is stored in the server 70 (see Steps S1, S3, and S5 of FIG. 6).

After that, in response to the keyword search instruction (instruction to perform a keyword search) from the client (search instruction apparatus) 50, the server 70 searches for a text object regarding the keyword specified by the user U1 (Steps S21 to S23 of FIG. 7). Then, the search result is transmitted to the client 50 (Step S24) and displayed on the client 50 (Step S25).

Hereinafter, further detailed description will be made, centering on the search process performed by the server 70.

<1-7. Detailed Operation 1 (Generation of Document to Storage of Document)>

First, the first half of the process, i.e., the storage of the electronic documents (electronic data) into the server 70, and the like, (Steps S1 to S5 (FIG. 6)) will be described.

In Step S1 of FIG. 6, the client (print instruction apparatus) 30 generates the print data (PDL data) of the document to be printed in accordance with the print instruction operation by the printing user U1. In more detail, when the printing user U1 performs a printing operation in an application, a printer driver is called from the application. The printer driver generates the print data (PDL data) of the document to be printed. As a format for the print data (PDL data), various formats such as PCL (Printer Command Language), XPS (XML Paper Specification), PostScript, and the like can be used.

The print data is transmitted to the MFP 10 (Step S2). The MFP 10 performs a printing operation on the basis of the received print data.

The print data is also transmitted to the server 70 (Step S3). The client 30 transmits the print data (PDL data) of the document to be printed and document name information of the document to be printed, to the server 70.

When the server 70 receives the print data (PDL data) and the document name information, the server 70 associates the print data with the document name information and stores the print data into the storage part 75 (Step S5).

Thus, the print data is stored in the server 70.

Further, by repeating such a storage process, the print data (a plurality of pieces of electronic document data) regarding a plurality of printed documents are accumulated in the server 70. Therefore, the server 70 is also referred to as a document accumulation apparatus.

<Attribute Information (Character Color/Font Type)>

In the first preferred embodiment, shown is a case where the print data described by a PDL (page description language) is a document to be searched.

This print data (PDL data) includes a plurality of text objects (characters). Further, in the print data, for each of the plurality of text objects, attributes thereof are defined. Herein, it is assumed that as the attributes of each text object, a “color attribute” of each text object and a “font attribute” of each text object are defined. Further, this is only one exemplary case, and as the attribute of each text object, only one of the “color attribute” and the “font attribute” may be defined. Alternatively, other attributes may be defined.

The “color attribute” is attribute information regarding a “color” of each character. For example, information of the color (“black”, “gray” (light color), or the like) of each character is defined as color attribute information.

Further, the “font attribute” is attribute information regarding a “font” of each character. For example, information of the font type (“Gothic type”, “Ming type”, or the like) of each character, information of a font style (“boldface type”, “italic type”, or the like) of each character, and/or the like are defined as a font attribute. Further, as the font attribute, a combination of the font type and the font style may be dealt as one attribute, or the font type and the font style may be dealt as different attributes. In other words, the font attribute is an attribute represented by at least one of the font type and the font style.

<1-8. Detailed Operation 2 (Start of Search to Display of Search Result)>

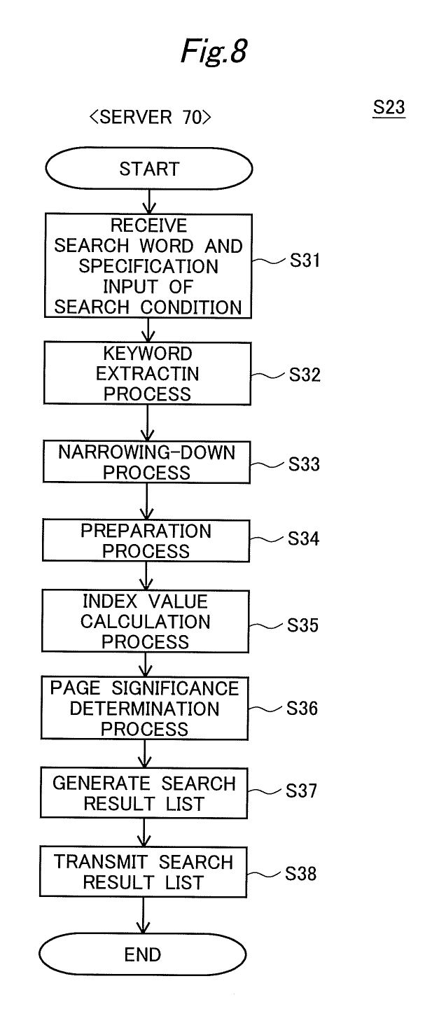

Next, the second half of the process, i.e., the search process performed by the server (search apparatus) 70 and the like (Steps S21 to S25 (FIG. 7)) will be described with reference to FIGS. 7 and 8. FIG. 8 is a flowchart showing an operation of the server 70.

<Search Instruction, etc.>

In Step S21 (see FIG. 7), first, the client (search instruction apparatus) 50 receives the keyword search instruction (instruction to perform a keyword search) from the search user U2.

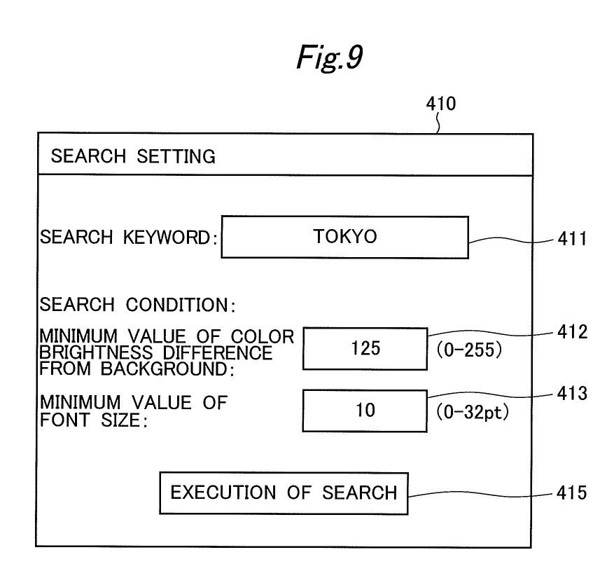

In more detail, the client 50 uses a web browser to access a web page for providing a search service of the server 70 and displays thereon a homepage screen for search transmitted back from the server 70. The search user U2 selects a “search command” from the homepage screen. The web browser of the client 50 transmits a notice that the search command is selected to the server 70, and receives display data of a search screen from the server 70. Then, on the basis of the display data, a search screen 410 (FIG. 9) is displayed on the display part of the client 50.

As shown in FIG. 9, the search screen 410 has an input field 411 for the search keyword and threshold value specification fields 412 and 413 regarding search conditions. Further, the search screen 410 also has a search execution button 415.

The input field 411 for the search keyword is an input field for specifying a keyword to be searched for. Further, the threshold value specification field 412 is an input field for specifying a minimum value (threshold value) TH1 of a color brightness difference, and the threshold value specification field 413 is an input field for specifying a minimum value (threshold value) TH2 of the font size. In the threshold value specification fields 412 and 413, default values (“125” and “10”) are inputted in advance and displayed, respectively.

The search user U2 inputs a desired keyword (for example, “TOKYO”) in the input field 411, and when the search user U2 intends to change the threshold values, the search user U2 changes the values in the threshold value specification fields 412 and 413, respectively. Then, the search user U2 presses the search execution button 415.

When the search user U2 presses the search execution button 415, the client 50 (in detail, the web browser) transfers the keyword search instruction and the specified keyword (keyword inputted and specified by the search user U2) to the server 70 (Step S22). Further, the information of the threshold values TH1 and TH2 are also transmitted from the client 50 to the server 70.

In Step S23, the server 70 searches a plurality of electronic documents stored in the server 70 for the text object regarding the specified keyword in response to the keyword search instruction. Hereinafter, with reference to the flowchart of FIG. 8, the operation (Step S23) of the server 70 will be described in more detail.

<Start of Search>

When the server 70 receives the information (the keyword search instruction, the specified keyword (“TOKYO” or the like), the threshold values TH1 and TH2, and the like) in Step S31, the server 70 starts the search process on the specified keyword in Step S32. Specifically, the server 70 first extracts a text object (text objects) including the specified keyword (also referred to as the search keyword) out of a plurality of text objects in one or more electronic documents (PDL data) to be searched. In other words, the keyword extraction process is performed.

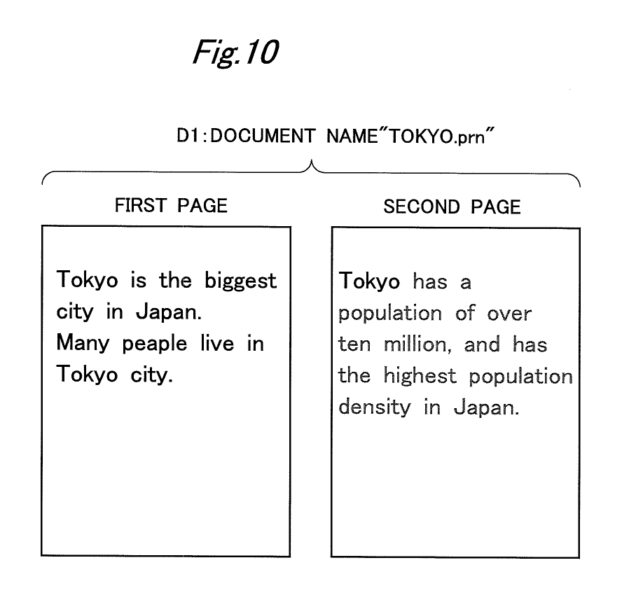

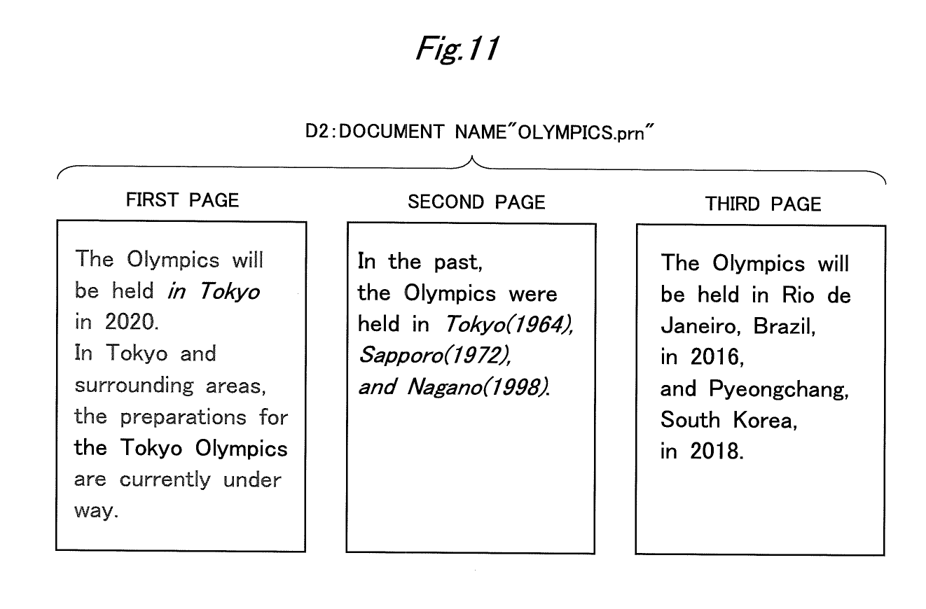

FIGS. 10 and 11 are views showing two documents from which the text objects including the search keyword are extracted. FIG. 10 is a view showing a first document D1 from which the search keyword is extracted, and FIG. 11 is a view showing a second document D2 from which the search keyword is extracted. As shown in FIGS. 10 and 11, for example, seven text objects “TOKYO” are extracted from the plurality of electronic documents (PDL data), as a search result (provisional result) of the keyword search.

In detail, as shown in FIG. 10, three text objects “TOKYO” are extracted from the first document (PDL data) D1 having a document name of “TOKYO.prn” and consisting of two pages. In more detail, the text object “TOKYO” on the first line of the first page, the text object “TOKYO” on the fourth line of the first page, and the text object “TOKYO” on the first line of the second page are extracted.

Further, as shown in FIG. 11, four text objects “TOKYO” are extracted from the second document (PDL data) D2 having a document name of “OLYMPICS.prn” and consisting of three pages. In more detail, the text object “TOKYO” on the second line of the first page, the text object “TOKYO” on the fourth line of the first page, the text object “TOKYO” on the seventh line of the first page, and the text object “TOKYO” on the third line of the second page are extracted.

<Narrowing-Down Process>

Next, in Step S33, the server 70 excludes some of the plurality of text objects, each of which has a significance determined to be not larger than a predetermined degree, from the search result. In short, a text object satisfying an exclusion condition is excluded from the search result and the search result is thereby narrowed down.

Specifically, among the plurality of text objects, a text object having a font size smaller than the threshold value (the minimum value of the font size) TH2 (in short, an undistinguished text object) is excluded from the search result. This is because the degree of significance of the information represented by a character string (character strings) written by letters smaller than a predetermined degree is not so high in most cases.

Further, a text object having a difference (also referred to as a color brightness difference) between the color brightness of the character string and that of the background thereof, which is smaller than the predetermined threshold value TH1, is also excluded from the search result. In short, a text object (undistinguished text object) having a color brightness difference smaller than the threshold value TH1 is excluded from the search result. This is because the degree of significance of the information represented by a character string (character strings) written by letters with a small color brightness difference from the background thereof (for example, a character string written in pale yellow (or pale gray) against a white background, or the like) is not so high in most cases.

The color brightness difference is a difference (in detail, the absolute value thereof) between the color brightness Cb of the character string(s) of the text object to be evaluated and the color brightness Cb of the background of the character string(s). As each color brightness Cb, for example, a value (“Color brightness”) (also referred to as Cb) expressed by the following Equation (1), which is proposed by W3C (WORLD WIDE WEB CONSORTIUM), may be used.

$$Cb = \frac{( R \times 299 ) + ( G \times 587 ) + ( B \times 114 )}{1000} \qquad ( 1 )$$

Further, the value R refers to an R (Red) component value (value ranging from 0 to 255) represented by 8 bits. Similarly, the value G refers to a G (Green) component value (value ranging from 0 to 255) represented by 8 bits, and the value B refers to a B (Blue) component value (value ranging from 0 to 255) represented by 8 bits.

Thus, a text object satisfying either one of the two exclusion conditions (the condition regarding the font size and the condition regarding the color brightness difference) is excluded from the search result.

Further, in the exemplary cases of FIGS. 10 and 11, the extracted seven text objects “TOKYO” satisfies none of the two exclusion conditions and therefore are not excluded from the search result.

<Significance Evaluation of Each Text Object>

Next, the server 70 calculates an index value V (described next) for each of the text objects extracted as the search result (in detail, the text objects after being subjected to the above-described narrowing-down process) (Steps S34 and S35).

The index value V is an index value indicating the rarity (rarity within a unit region) of an attribute of the text object to be evaluated.

In the first preferred embodiment, the index value V is calculated on the basis of the following Equations (2) to (4). The index value V is an evaluation value based on values N1, N2, and Z.

$$\begin{matrix}V = V 1 \times V 2 & ( 2 ) \\ V 1 = \frac{1}{\frac{N 1}{Z}} = \frac{Z}{N 1} & ( 3 ) \\ V 2 = \frac{1}{\frac{N 2}{Z}} = \frac{Z}{N 2} & ( 4 )\end{matrix}$$

In the above Equations, the value N1 refers to the number of characters of text objects having the same color attribute as that of the text object to be evaluated in a unit region. The value N2 refers to the number of characters of text objects having the same font attribute as that of the text object to be evaluated in the unit region. The value Z refers to the total number of characters in the unit region including the text object to be evaluated. In the first preferred embodiment, a “page” (of each electronic document) is adopted as the unit region.

In the above Equations, the value V1 refers to a reciprocal of a ratio (N1/Z) of the number N1 of characters of the character strings having a color attribute (for example, “gray” or “black”) in the unit region, to the total number Z of characters. As the number N1 of characters of the character strings having the color attribute in the unit region becomes smaller, the value V1 becomes larger. Therefore, the value V1 is also a value indicating the rarity of the character string having the color attribute in the unit region. In detail, as the value V1 becomes larger, it is determined that the rarity becomes higher.

Similarly, the value V2 refers to a reciprocal of a ratio (N2/Z) of the number N2 of characters of the character strings having a font attribute (for example, “Gothic type and italic type”, “Gothic type and normal type”, “Ming type and boldface type”, or the like) in the unit region, to the total number Z of characters. As the number N2 of characters of the character strings having the font attribute in the unit region becomes smaller, the value V2 becomes larger. Therefore, the value V2 is also a value indicating the rarity of the character string having the font attribute in the unit region. In detail, as the value V2 becomes larger, it is determined that the rarity becomes higher.

Further, the index value V is the product of the value V1 and the value V2. Therefore, as the number of character strings having the same attribute as that of a text object in the unit region becomes smaller, the index value V becomes larger. Therefore, the index value V is also a value indicating the rarity of the character string having the attribute (the same attribute as that of the text object to be evaluated) in the unit region. In detail, as the value V becomes larger, it is determined that the rarity becomes higher.

Though it is defined herein that the value V1 is a reciprocal of the value (N1/Z), the value V1 is not limited to this but the value V1 may be the value (N1/Z) itself. Similarly, the value V2 may be the value (N2/Z) itself. In this case, as the value V1 or V2 (accordingly, the value V) becomes smaller, it may be determined that the rarity becomes higher.

Further, in the first preferred embodiment, the index value V is calculated with a “page” as the unit region. Therefore, it is possible to determine the degree of significance of the text object to be evaluated, with the local reference in a unit of a “page”. Particularly, since it is not necessary to take the information (the number of characters or the like) on the pages other than the page including the text object to be evaluated into consideration, it is possible to calculate the index value V at a relatively high speed.

For the calculation of the index value V, first in Step S34, the server 70 analyzes the data (PDL data) of each page including the text object to be evaluated (herein, each of the respective character strings 211 to 217 of the seven text objects), to thereby acquire the following preparation information. Specifically, as the preparation information, the above-described values Z, N1, and N2 are acquired for each text object.

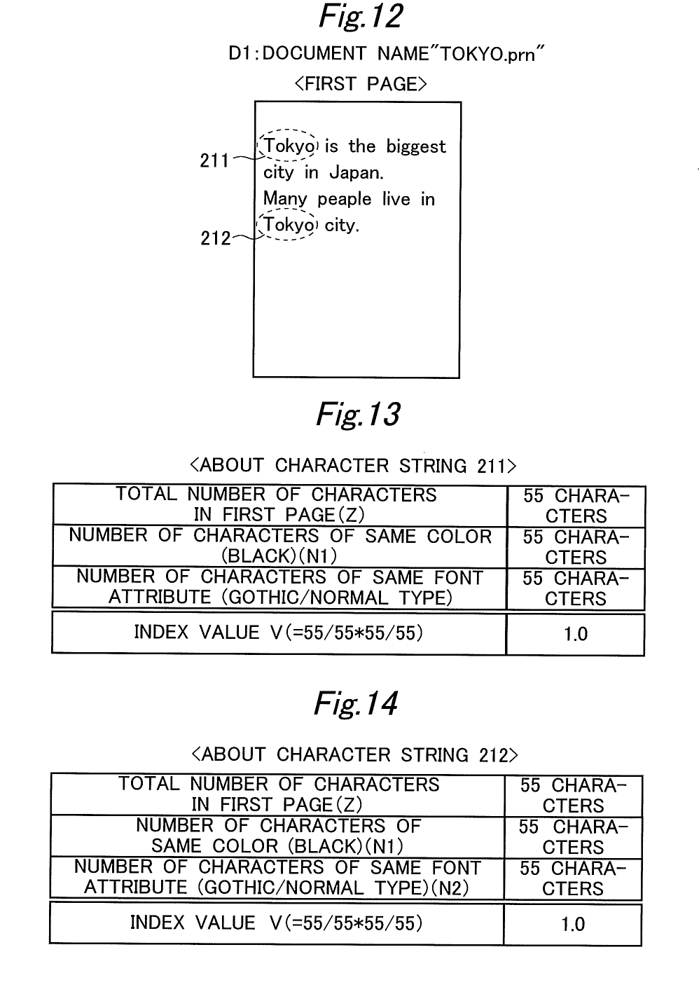

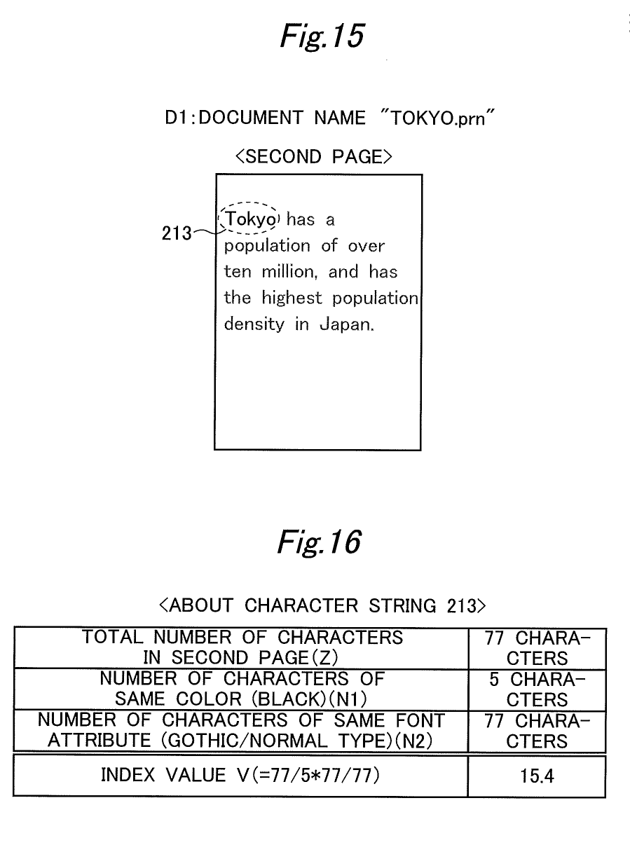

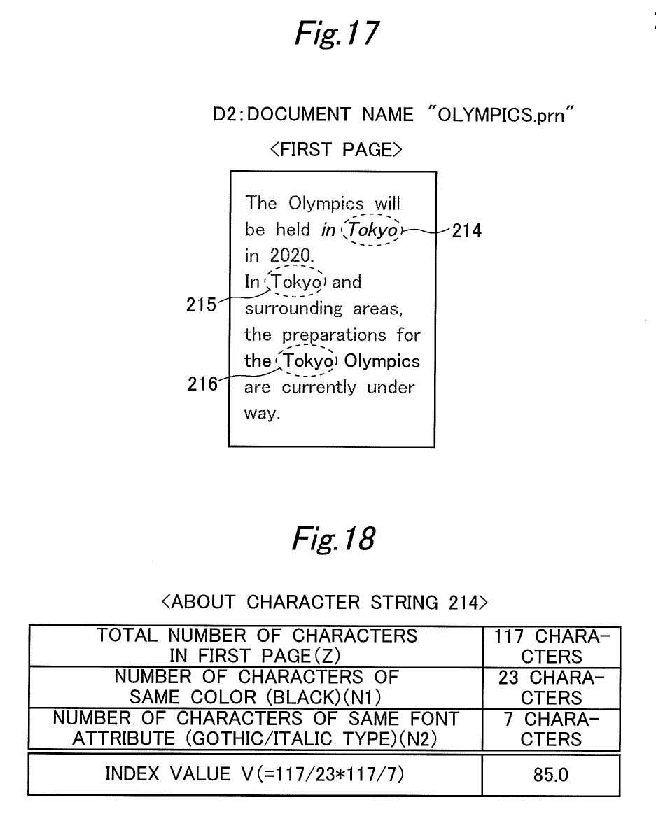

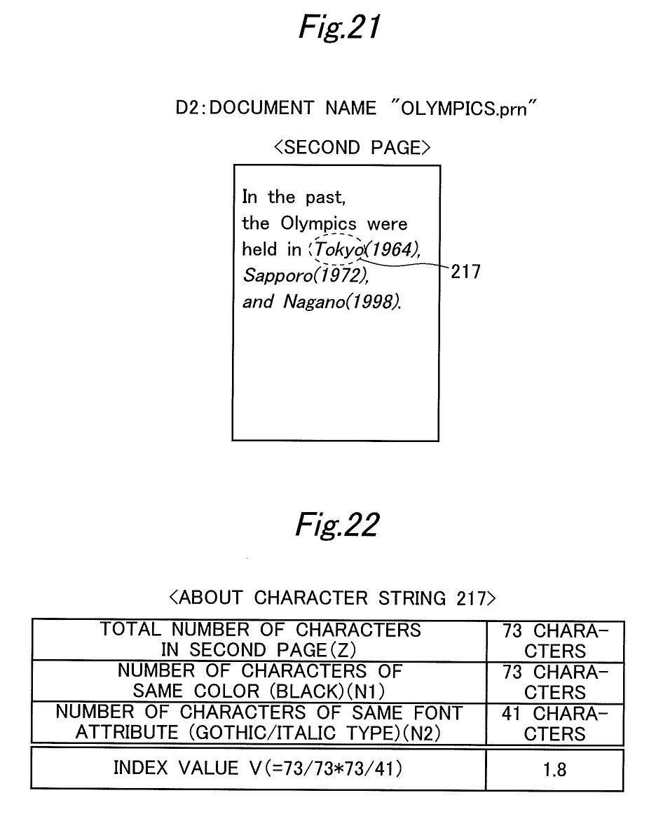

The server 70 counts and acquires the total number Z of characters in each page including the text object to be evaluated. Further, herein, the seven text objects to be evaluated are included in four pages (the first and second pages of the electronic document D1, and the first and second pages of the electronic document D2). FIGS. 12, 15, 17, and 21 show the seven text objects (the character strings 211 to 217). FIG. 12 is a view showing the first page of the document D1, and FIG. 15 is a view showing the second page of the document D1. Further, FIG. 17 is a view showing the first page of the document D2, and FIG. 21 is a view showing the second page of the document D2.

For example, since the character string 211 (FIG. 12) is included in the first page of the electronic document D1, with respect to the text object including the character string 211, the total number of characters (“55 characters”) in the first page of the electronic document D1 is acquired as the value Z (see FIG. 13). Also with respect to the character string 212, the total number of characters (“55 characters”) in the first page of the electronic document D1 is acquired as the value Z (see FIG. 14).

Similarly, with respect to the character string 213 (FIG. 15), the total number of characters (“77 characters”) in the second page of the electronic document D1 is acquired as the value Z (see FIG. 16). Further, with respect to the character strings 214 to 216 (FIG. 17), the total number of characters (“117 characters”) in the first page of the electronic document D2 is acquired as the value Z (see FIGS. 18 to 20). Furthermore, with respect to the character string 217 (FIG. 21), the total number of characters (“73 characters”) in the second page of the electronic document D2 is acquired as the value Z (see FIG. 22).

Further, the server 70 counts and acquires the number of characters of the text objects having the same attribute as that of the text object to be evaluated in the same page. In more detail, with respect to each text object, the above-described values N1 and N2 are obtained. The value N1 refers to the number of characters of the text objects having the same color attribute as that of the text object to be evaluated in the unit region. Further, the value N2 refers to the number of characters of the text objects having the same font attribute as that of the text object to be evaluated in the unit region.

For example, with respect to the text object including the character string 211 (see FIG. 12), the number of characters (“55 characters”) of the text objects having the same color attribute as that (“black”) of the above text object in the unit region is acquired as the value N1 (see FIG. 13). Moreover, the number of characters (“55 characters”) of the text objects having the same font attribute as that (“Gothic type and normal type”) of the text object to be evaluated in the unit region is acquired as the value N2.

Further, with respect to the text object including the character string 214 (see FIG. 17), the number of characters (“23 characters”) of the text objects having the same color attribute as that (“black”) of the above text object in the unit region is acquired as the value N1 (see FIG. 18). Moreover, the number of characters (“7 characters”) of the text objects having the same font attribute as that (“Gothic type and italic type”) of the text object to be evaluated in the unit region is acquired as the value N2.

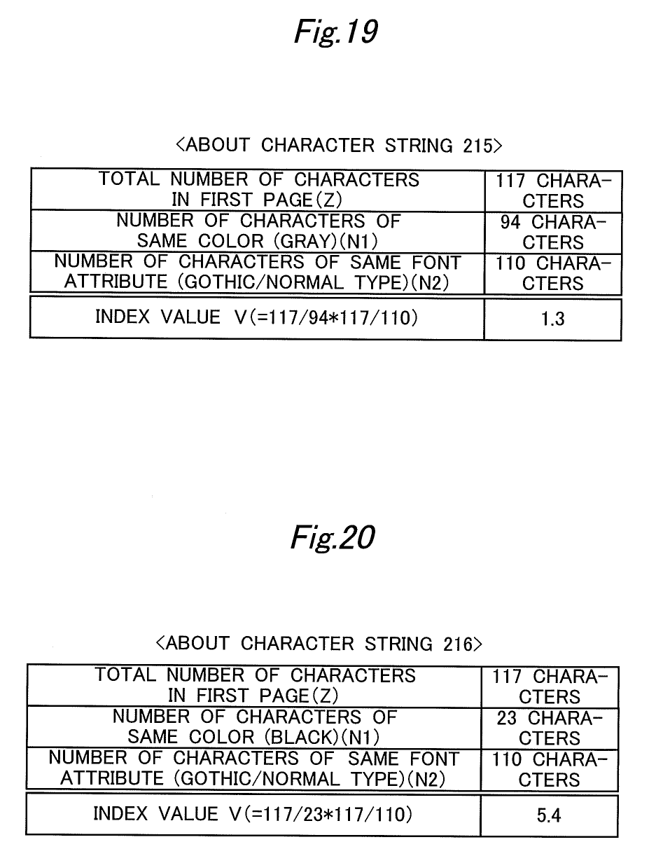

Furthermore, with respect to the text object including the character string 215 (see FIG. 17), the number of characters (“94 characters”) of the text objects having the same color attribute as that (“gray”) of the above text object in the unit region is acquired as the value N1 (see FIG. 19). Moreover, the number of characters (“110 characters”) of the text objects having the same font attribute as that (“Gothic type and normal type”) of the text object to be evaluated in the unit region is acquired as the value N2.

With respect to each of other text objects (each of other character strings 212, 213, 226, and 227), similarly, the values N1 and N2 are obtained.

Then, in Step S35, on the basis of the above-described Equations (2) to (4), the index value V of each of the text objects is calculated.

For example, with respect to the text object including the character string 211 (see FIG. 12), the index value V (“1.0”) is calculated, as shown in FIG. 13. In detail, on the basis of the respective values, Z=55, N1=55, and N2=55, the value V1 is “55/55” and the value V2 is “55/55”. Therefore, “1.0” (=(55/55)*(55/55)) is calculated as the index value V.

With respect to the text object including the character string 212 (see FIG. 12), similarly, the value V is calculated as “1.0” (=(55/55*(55/55)) (see FIG. 14).

Further, with respect to the text object including the character string 213 (see FIG. 15), the index value V (“15.4”) is calculated, as shown in FIG. 16. In detail, on the basis of the respective values, Z=77, N1=5, and N2=77, the value V1 is “77/5” and the value V2 is “77/77”. Therefore, “15.4” (=(77/5)*(77/77)) is calculated as the index value V.

Furthermore, with respect to the text object including the character string 214 (see FIG. 17), the index value V (“85.0”) is calculated, as shown in FIG. 18. In detail, on the basis of the respective values, Z=117, N1=23, and N2=7, the value V1 is “117/23” and the value V2 is “117/7”. Therefore, “85.0” (=(117/23)*(117/7)) is calculated as the index value V.

Similarly, with respect to the text object including the character string 215 (see FIG. 17), the index value V (“1.3”) is calculated, as shown in FIG. 19. In detail, on the basis of the respective values, Z=117, N1=94, and N2=110, the value V1 is “117/94” and the value V2 is “117/110”. Therefore, “1.3” (=(117/94)*(117/110)) is calculated as the index value V.

Still similarly, with respect to the text object including the character string 216 (see FIG. 17), the index value V (“5.4”) is calculated, as shown in FIG. 20. In detail, on the basis of the respective values, Z=117, N1=23, and N2=110, the value V1 is “117/23” and the value V2 is “117/110”. Therefore, “5.4” (=(117/23)*(117/110)) is calculated as the index value V.

Further, with respect to the text object including the character string 217 (see FIG. 21), the index value V (“1.8”) is calculated, as shown in FIG. 22. In detail, on the basis of the respective values, Z=73, N1=73 and N2=41, the value V1 is “73/73” and the value V2 is “73/41”. Therefore, “1.8” (=(73/73)*(73/41)) is calculated as the index value V.

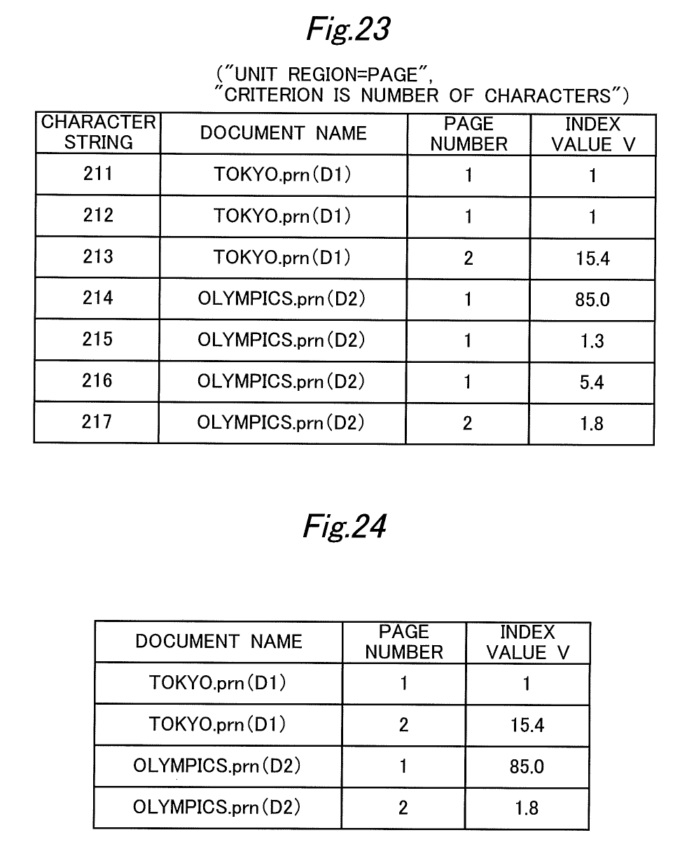

FIG. 23 is a view showing the respective index values V of the text objects (the character strings 211 to 217) in a list format.

Thus, the index value V indicating the rarity of the attribute of each text object to be evaluated is calculated (acquired).

Further, on the basis of the index value V of each text object, the degree of significance of the text object is determined. Herein, the index value V itself is determined as the degree of significance of the text object. The degree of significance of each text object is determined on the basis of the index value V indicating the rarity (rarity in the unit region) of the attribute of the text object. In more detail, it is determined that a text object having a relatively high level of rarity has a relatively high degree of significance. In other words, it is determined that a text object having a rare attribute in the unit region (a text object having an appearance different from the others (in short, a distinguished object)) has a high degree of significance.

<Significance Evaluation of Page>

Next, in Step S36, the server 70 determines the degree of significance of a page including each text object to be evaluated.

Basically, the degree of significance of the page including each text object to be evaluated is determined to be the same value as the index value V (the degree of significance) of the text object. When a plurality of text objects are present in the same page, however, the highest one of the plurality of index values V on the plurality of text objects is determined as the degree of significance of the page.

Thus, the degree of significance of the text object (character string) having the highest degree of significance in a unit region (herein, a “page”) is determined as the degree of significance of the unit region.

FIG. 24 is a view showing a calculation result of the degree of significance of each page. As can be seen from the comparison with FIG. 23, as the degree of significance of the first page of the document D1, determined is a higher one (“1.0”) of the two index values V (herein, the same value) on the two character strings 211 and 212. Further, as the degree of significance of the second page of the document D1, determined is the index value V (“15.4”) on the character string 213. Furthermore, as the degree of significance of the first page of the document D2, determined is a highest one (“85.0”) of the three index values V on the three character strings 214, 215, and 216. Moreover, as the degree of significance of the second page of the document D2, determined is the index value V (“1.8”) on the character string 217.

<Generation of List>

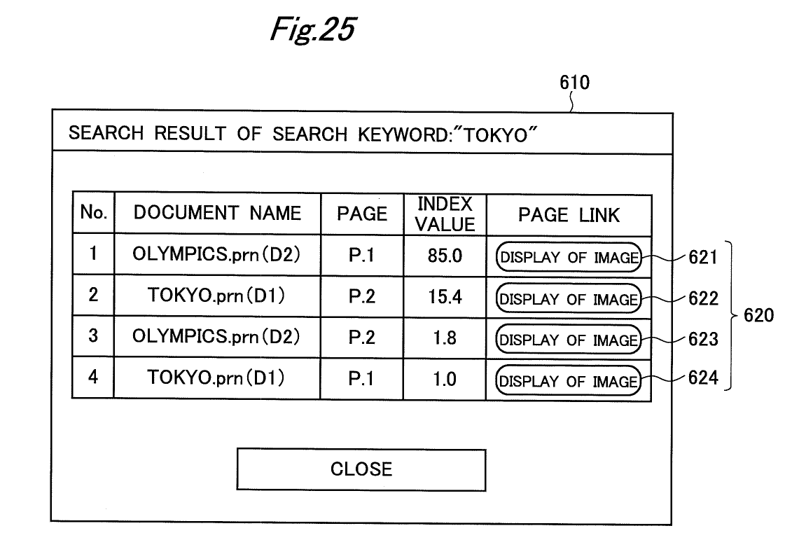

Next, in Step S37, the server 70 generates a search result list 610. The search result list 610 is a list in which the pages each including at least one text object retrieved in the keyword extraction process (keyword search process) of Step S32 are arranged in accordance with the degree of significance of each page (see FIG. 25).

Further, the server 70 generates image data (display data) of the search result list 610 (by using software RIP or the like).

In next Step S38, the server 70 transmits web page data (the display data of the search result list 610) including the image data and the like, as the search result, to the client 50.

<Display of Search Result>

With reference back to FIG. 7, description will be made.

When the client 50 receives the search result (the web page data including the image data and the like) from the server 70 (Step S24), the client 50 displays thereon the received search result (Step S25). Specifically, the search result list 610 (FIG. 5) based on the web page data is displayed on the display part 56b (Step S25).

In the search result list 610 of FIG. 25, the four pages including the seven text objects are arranged from the top line (No. 1) toward the bottom line (No. 4) in descending order of the degree of significance thereof. Further, in each line (row) of the search result list 610, the document name, the page number, the degree of significance (index value V), and an image display instruction button 620 are displayed.

Specifically, in the top row (top line), displayed is the page (the first page of the document D2) having the highest degree of significance of “85.0”. In the second row from the top, displayed is the page (the second page of the document D1) having the second highest degree of significance of “15.4”. In the third row from the top, displayed is the page (the second page of the document D2) having the third highest degree of significance of “1.8”. Then, in the bottom row, displayed is the page (the first page of the document D1) having the lowest degree of significance of “1.0”.

When the search user U2 presses a desired one (for example, a button 621) of the image display instruction buttons 620 (621 to 624) corresponding to the respective lines in the search result list 610, the client 50 transmits a transmission instruction of a page image corresponding to the pressed button 620, to the server 70.

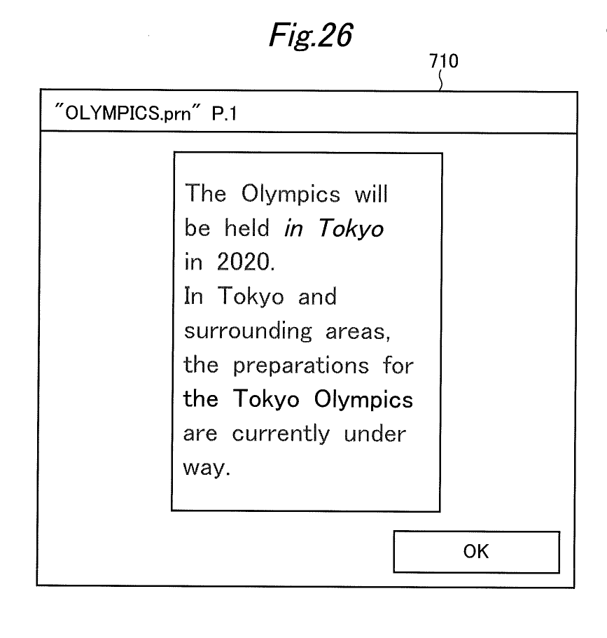

In response to the transmission instruction, the server 70 generates the image data of the image (page image) of the corresponding page and transmits the web page data including the image data to the client 50. When the client 50 receives the web page data, the client 50 displays thereon a display screen 710 of the corresponding page image (see FIG. 26) on the basis of the web page data.

FIG. 26 shows a state in which the first page of the document D2 (the page having the highest degree of significance) is displayed in response to the press operation of the button 621.

Further, the search keyword in the page may be highlighted (for example, in a marking display with a specific color (in a yellow marking display or the like)).

The search user U2 can thereby visually recognize the search result. Particularly, by using the search result list in which the retrieved results are arranged in order of the degree of significance, the search user U2 can relatively easily view the page having a relatively high degree of significance among the plurality of retrieved results.

<1-9. Effects or the Like of the First Preferred Embodiment>

Herein, description will be made on a technique, as a comparative example, where it is determined whether a character string is significant or not only in accordance with whether the attribute (the color attribute or the font attribute) of the character string is a specific attribute or not.

Generally in some cases, in a document, normal information is displayed by letters having a font attribute (for example, Ming type) and relatively significant information is displayed by letters having another font attribute (for example, Gothic type). In the other case, however, in another document, normal information is displayed by letters having another font attribute (for example, Gothic type) and relatively significant information is displayed by letters having a font attribute different from another font attribute (for example, Ming type or further different font), or the like.

Therefore, it is difficult to determine whether a character string is significant or not only in accordance with whether or not the character string has a specific font attribute (for example, “Gothic type”).

Similarly, in some cases, in a document, normal information is displayed by black letters and significant information is displayed by letters of another color (for example, red). In the other case, however, in another document, normal information is displayed by gray letters and significant information is displayed by letters of another color (for example, black).

Therefore, it is difficult to determine whether a character string is significant or not only in accordance with whether or not the character string has a specific color attribute (for example, red).

Thus, it is difficult to determine whether a detected text object is significant or not only in accordance with whether or not the attribute (the color attribute and/or the font attribute) of the text object (character string) is a specific one. In other words, it is not always easy to appropriately determine the degree of significance of each text object extracted from an electronic document.

On the other hand, in accordance with the above-described preferred embodiment, in Step S35 (FIG. 8), the index value V indicating the rarity of the attribute of one text object retrieved by the keyword search regarding one or more electronic documents is acquired and the degree of significance of the one text object is determined on the basis of the index value V. The index value V is an index value based on a contrast between the total number of characters in a unit region including the one text object and the number of characters of text objects having the same attribute as that of the one text object in the unit region. Therefore, it is possible to appropriately determine the degree of significance of the character string retrieved by the keyword search.

In particular, even if the user or the like does not specify an attribute having the rarity in advance, a rare attribute is automatically determined and a text object corresponding to the rare attribute is retrieved as one having a relatively high degree of significance. Therefore, the user can relatively easily access highly significant information. Further, it is not necessary for the user to specify a specific attribute individually for each of various electronic documents. Therefore, it is possible to relatively easily access significant information in various electronic documents.

Further, the document to be searched in the above-described preferred embodiment does not need to have a specific format (format in which the chapter structure of a document is specifically defined, or the like) but may have a general format in which attributes (the color attribute, the font attribute, and/or the like) of each character are defined. Therefore, the search technique of the present preferred embodiment can be applied to electronic documents of relatively various formats.

Furthermore, since the index value V is calculated by using relatively simple equations based on a ratio (in detail, a reciprocal of a ratio) of character strings having the same attribute as that of the character string retrieved by the keyword search in a unit region, it is possible to relatively easily determine the degree of significance of each character string.

The index value V is a value based on the values V1 and V2. The value V1 is a value based on a contrast between the number N1 of characters of text objects having the same color attribute as that of one text object retrieved by the keyword search in the unit region and the total number Z of characters in the unit region including the one text object. The value V2 is a value based on a contrast between the number N2 of characters of text objects having the same font attribute as that of the one text object in the unit region and the total number Z of characters in the unit region. By using two types of attributes (the color attribute and the font attribute), it is possible to more appropriately determine the degree of significance of each text object (character string).

Moreover, in the above-described present preferred embodiment, on the basis of the degree of significance of each text object, the degree of significance of each page is determined (in Step S36). Then, in the search result list 610, a plurality of pages including the search keyword are listed on a page-by-page basis in descending order of the degree of significance thereof (Step S25). Therefore, the search user U2 can relatively easily access the page including significant information. When the search user intends to check a word (keyword), particularly, it is convenient to view a sentence including the keyword in a unit of a page, and the search result list 610 is very suitable for such a viewing on a page-by-page basis.

Further, an undistinguished character string (character string having a font size smaller than the threshold value TH2 and/or character string having a color brightness difference from the background thereof, which is smaller than the threshold value TH1) is excluded from the search result of the keyword search. Therefore, information regarded to be relatively less significant is excluded from the search result, and a relatively small number of narrowed-down retrieved results (high-quality retrieved results) can be provided to the user.

Furthermore, since the threshold values TH1 and TH2 are changeable by the user, it is possible for the user to control the degree of narrowing down as appropriate as necessary.

### 2. The Second Preferred Embodiment

The second preferred embodiment is a variation of the first preferred embodiment. Hereinafter, description will be made, centering on the difference between the first and second preferred embodiments.

Though the search result is displayed on a page-by-page basis in the above-described first preferred embodiment, this is only one exemplary case and the search result may be displayed on a document-by-document basis. Such an aspect will be shown in the second preferred embodiment.

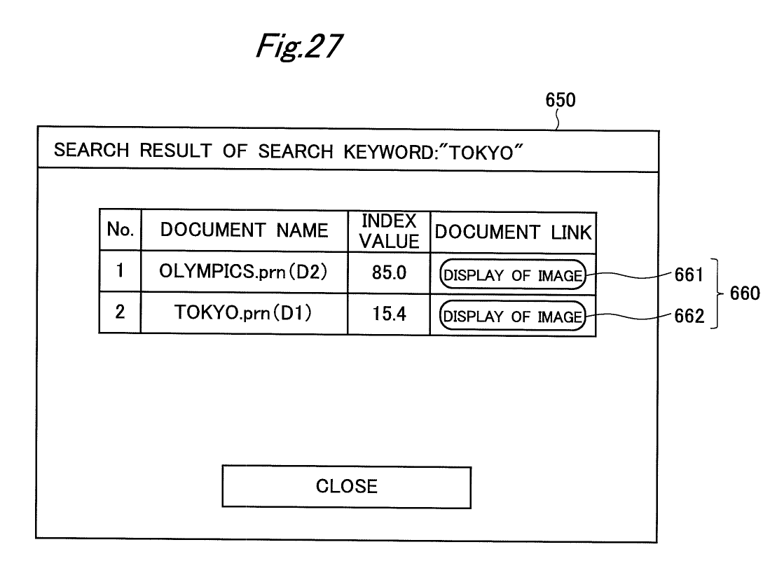

In the second preferred embodiment, instead of the search result list 610 in a unit of a page (see FIG. 25), a search result list 650 in a unit of an electronic document (see FIG. 27) is generated (Step S37) and the search result list 650 is displayed on the client 50 (Step S25). In the search result list 650, electronic documents each including at least one text object retrieved by the keyword search from a plurality of electronic documents are arranged in accordance with the degree of significance of each electronic document.

Specifically, in Step S36 of FIG. 8, additionally to the significance determination process for each page, a significance determination process for each electronic document is further performed.

In Step S36, like in the first preferred embodiment, the significance determination process for each page is first performed, to thereby obtain the calculation result of the degree of significance of each page (see FIG. 24). In the second preferred embodiment, in Step S36, the degree of significance of each of a plurality of electronic documents including the extracted pages is further calculated. In detail, the degree of significance of the page having the highest degree of significance in an electronic document is determined as the degree of significance of the electronic document.

As shown in FIG. 24, for example, in the document D1, the search keyword is included in two pages. The degree of significance of each page is determined like in the first preferred embodiment. Specifically, the degree of significance of the first page of the document D1 is “1.0”, and the degree of significance of the second page of the document D1 is “15.4”. Then, on the basis of these information, the highest one, “15.4”, of these values is determined as the degree of significance of the document D1.

Similarly, in the document D2, the search keyword is included in two pages. The degree of significance of each page is determined like in the first preferred embodiment. Specifically, the degree of significance of the first page of the document D2 is “85.0”, and the degree of significance of the second page of the document D2 is “1.8”. Then, on the basis of these information, the highest one, “85.0”, of these values is determined as the degree of significance of the document D2.

In next Step S37, the server 70 generates the search result list 650 (FIG. 27) on the basis of the above determinations. FIG. 27 is a view showing the search result list 650.

Further, in Step S38, the server 70 transmits the display data of the search result list 650 to the client 50 as the search result.

Then, when the client 50 receives the display data of the search result list 650 from the server 70 (Step S24), the client 50 displays thereon the search result list 650 on the basis of the received display data (Step S25).

In the search result list 650 of FIG. 27, the two documents including the seven text objects are arranged from top toward bottom in descending order of the degree of significance thereof. Further, in each line (row) of the search result list 650, the document name, the degree of significance (index value V), and an image display instruction button 660 are displayed.

When the search user U2 presses a desired one (for example, a button 661) of the image display instruction buttons 660 (661 and 662) corresponding to the respective lines in the search result list 650, the client 50 transmits a transmission instruction of a page image the document (D2) corresponding to the pressed button (661), to the server 70.

In response to the transmission instruction, the server 70 generates the image data of the page image of the corresponding document (e.g., D2). For example, the page (first page) having the highest degree of significance among the pages in the document D2 is selected as the first page to be displayed and the page image for the first page to be displayed is generated. Then, the web page data including the image data is transmitted from the server 70 to the client 50.

When the client 50 receives the web page data, the client 50 displays thereon a screen 710 of the corresponding page (see FIG. 26) on the basis of the web page data. In other words, in response to the press operation of the button 661, the page image of the first page (the page having the highest degree of significance) in the document D2 is displayed as the first page to be displayed.

Thus, the search user U2 can thereby visually recognize the search result. Particularly, in the search result list 650, two or more (herein, two) electronic documents including the search keyword are arranged in order of the degree of significance. Therefore, by using the search result list 650, the search user U2 can relatively easily access the electronic document having a relatively high degree of significance among the plurality of retrieved results.

Further, in the screen 710 of FIG. 26, a page change button (“previous-page display button”, “next-page display button”, or the like) (not shown) may be further provided. Then, in response to the press operation of the page change button, the page to be displayed may be updated (to an immediately preceding page, an immediately following page, or the like). Further, another page change button for jumping to another page including the search keyword (“next-rank page display button” or the like) may be further provided. In response to the press operation of the next-rank page display button, the page to be displayed may be changed to the next-rank page (the page having the index value V next to that of the page being displayed). Furthermore, a “previous-rank page display button” for changing the page to the reverse direction, or the like, may be provided.

### 3. The Third Preferred Embodiment

The third preferred embodiment is a variation of the first preferred embodiment and the like. Hereinafter, description will be made, centering on the difference between the first and third preferred embodiments.

Though the print data (PDL data) or the like is used as the electronic document to be searched in the above-described preferred embodiments, this is only one exemplary case. Data of other formats may be used as the electronic document to be searched.

As exemplary data of other formats, shown are data generated by using various document generation application software programs (hereinafter, also referred to as applications). In more detail, various data such as document data generated by a word processor application, document data generated by a spreadsheet application, PDF data (document data) generated by a PDF-data generation application, and the like are shown as examples. Further, the data of other format may be data of HTML (HyperText Markup Language) generated by an HTML document generation application.

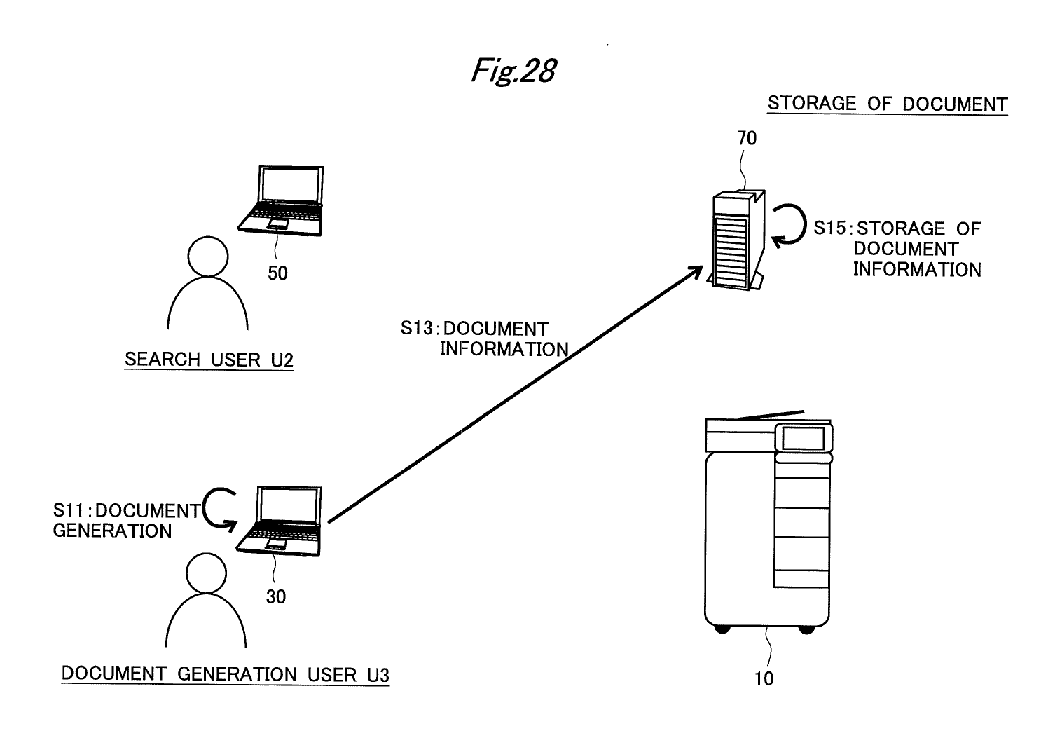

FIG. 28 is a view showing an operation of the third preferred embodiment. In the third preferred embodiment, the operation shown in FIG. 28 is performed, instead of the operation of FIG. 26.

Specifically, in Step S11, the data generation part 41 of the client 30 generates document data for various applications. In more detail, the document generation user U3 uses various document generation applications (word processor application and the like), to thereby generate document data of various formats.

Then, in Step S13, the client 30 transmits the document data to the server 70.

Further, in Step S15, the server 70 stores the document data received from the client 30, into the storage part 75.

After that, the server 70 performs the search process like in the above-described cases with the document data (electronic document) generated by the applications as an object to be searched.

Herein, the document data generated by the client 30 may be, for example, data having a text object, page delimiter information, and a color attribute and a font attribute of each text object.

### 4. The Fourth Preferred Embodiment

The fourth preferred embodiment is a variation of the first preferred embodiment and the like. Hereinafter, description will be made, centering on the difference between the first and fourth preferred embodiments.

Though the processes including Steps S34 and S35 (FIG. 8) described above are performed after the server 70 receives the search instruction from the client 50 in the above-described preferred embodiments, this is only one exemplary case. For example, a partial process (character number counting process) among a preparation process for performing Steps S34 and S35 may be performed in advance before the server 70 receives the search instruction from the client 50. Such an aspect will be shown in the fourth preferred embodiment. The partial process may be performed by the server 70 in advance, but description will be made herein on a case where the partial process is performed in advance on the side of the client 30.

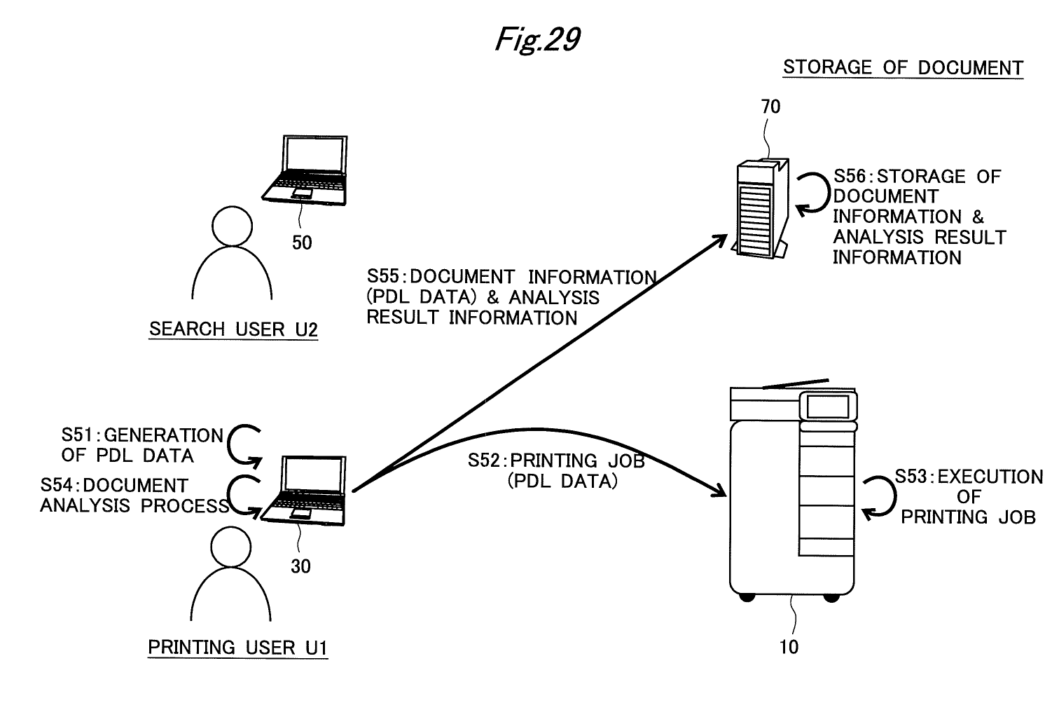

FIG. 29 is a view showing an operation of the fourth preferred embodiment. In the fourth preferred embodiment, the operation shown in FIG. 29 is performed, instead of the operation of FIG. 26.

Specifically, the processes of Steps S51, S52, and S53 are the same as those of Steps S1, S2, and S4 in FIG. 6, respectively.

In the fourth preferred embodiment, the analysis process (document analysis process) on the PDL data (electronic document) generated in Step S51 is performed by the client 30 in advance (before the search process) (Step S54). Further, the document analysis process (Step S54) may be performed after Steps S52 and S53 (immediately after these steps, or the like) but may be performed concurrently with Steps S52 and S53.

In Step S54, the client 30 (for example, the printer driver) analyzes the electronic document (PDL data) generated in Step S51, to thereby generate attribute information (attribute data) 810 on the electronic document. The attribute information 810 is information defining the total number of characters in each unit region (herein “page”), the number of characters for each color attribute in each unit region, and the number of characters for each font attribute in each unit region, on the electronic document. The attribute information is acquired for each electronic document.

When the document D2 is generated, for example, the attribute information 810 are acquired for each of the three pages of the document D2.

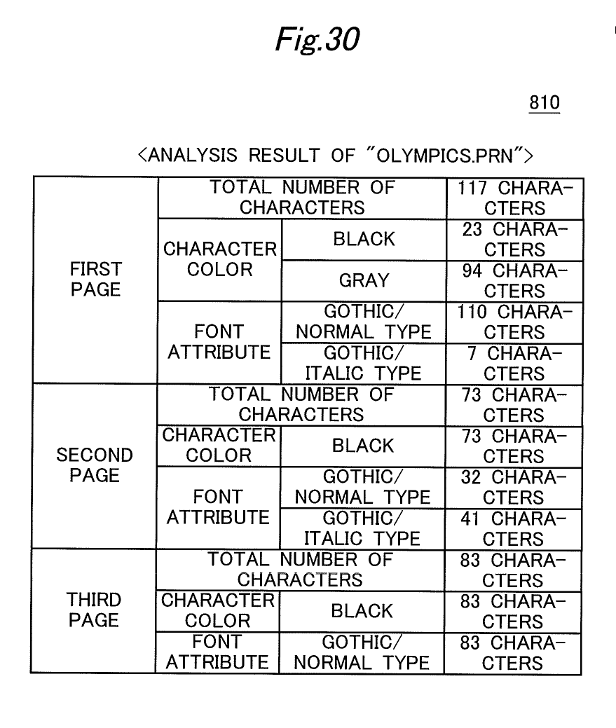

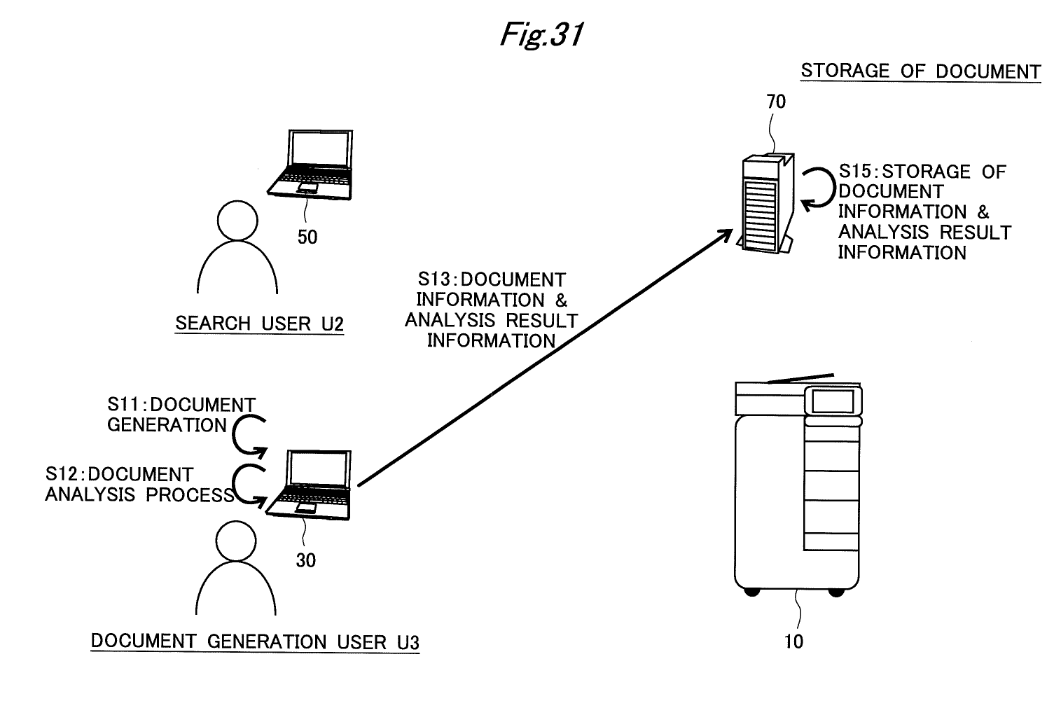

FIG. 30 is a view showing the attribute information 810 thus obtained.

Specifically, with respect to the document D2, the total number of characters (“117 characters”) of the first page, the number of characters for each color attribute (“black=23 characters”, “gray=94 characters”) in the first page, and the number of characters for each font attribute (“Gothic type and normal type=110 characters”, “Gothic type and italic type=7 characters”) in the first page are acquired, and defined in the attribute information 810. Further, the information indicating that two color attributes (“black” and “gray”) and two font attributes (“Gothic type and normal type” and “Gothic type and italic type”) are included in the first page is also defined in the attribute information 810.

Further, with respect to the document D2, the total number of characters (“73 characters”) of the second page, the number of characters for each color attribute (“black=73 characters”) in the second page, and the number of characters for each font attribute (“Gothic type and normal type=32 characters”, “Gothic type and italic type=41 characters”) in the second page are acquired, and defined in the attribute information 810. Further, the information indicating that one color attribute (“black”) and two font attributes (“Gothic type and normal type” and “Gothic type and italic type”) are included in the second page is also defined in the attribute information 810.

Furthermore, with respect to the document D2, the total number of characters (“83 characters”) of the third page, the number of characters for each color attribute (“black=83 characters”) in the third page, and the number of characters for each font attribute (“Gothic type and normal type=83 characters”) in the third page are acquired, and defined in the attribute information 810. Further, the information indicating that one color attribute (“black”) and one font attribute (“Gothic type and normal type”) are included in the third page is also defined in the attribute information 810.

Then, in Step S55, the client (for example, the printer driver) 30 transmits the information including both the attribute information 810 and the PDL data to the server 70. Further, though the client 30 transmits the attribute information 810 and the PDL data after the generation of the attribute information 810 herein, this is only one exemplary case and the PDL data may be transmitted before the generation of the attribute information 810.

When the server 70 receives these information (the PDL data, the attribute information 810, and the like), the server 70 associates these information with each other and stores these information into the storage part 75 (Step S56). In other words, in the storage part 75, not only the electronic document (PDL data) but also the attribute information 810 (FIG. 30) generated by the client (generation apparatus for each electronic document) 30 and received in advance from the client 30 is stored.

After that, when the search process is performed, the attribute information 810 is used.

Also in the fourth preferred embodiment, like in the first preferred embodiment and the like, the operations shown in FIGS. 7 and 8 are performed. In Step S34 of FIG. 8, however, an operation different from that in the first preferred embodiment is performed, to thereby acquire the values Z, N1 and N2 at a very high speed.

Specifically, the index value V of each text object (each of the character strings 221 to 227) is generated by using the attribute information 810 shown in FIG. 30.

Herein, since the attribute information 810 already includes the value Z (acquired by the client 30), the server 70 does not need to count the value Z.

Further, the server 70 uses the attribute information 810, to thereby also acquire the values N1 and N2 without counting.

Specifically, the server 70 first specifies one color attribute which is the same as that of one text object to be evaluated. Then, the server 70 acquires the number N1 of characters of the text objects having the one color attribute in the unit region, on the basis of the attribute information 810.

Further, the server 70 specifies one font attribute which is the same as that of the one text object. Then, the server 70 acquires the number N2 of characters of the text objects having the one font attribute in the unit region, on the basis of the attribute information 810.

Herein, in the attribute information 810, the number of characters of the text objects with each of all the color attributes is (already) defined for each unit region. Therefore, when the color attribute corresponding to each character string is specified, the number N1 of characters corresponding to the specified color attribute is instantly acquired on the basis of the attribute information 810.

Similarly, in the attribute information 810, the number of characters of the text objects with each of all the font attributes is (already) defined for each unit region. Therefore, when the font attribute corresponding to each character string is specified, the number N2 of characters corresponding to the specified font attribute is instantly acquired on the basis of the attribute information 810.

After that, like in the first preferred embodiment, in Step S35 of FIG. 8, the index value V is calculated for each text object on the basis of the values Z, N1 and N2.

Further, the processes in Step S36 and the following steps are also performed like in the first preferred embodiment.

Thus, in the fourth preferred embodiment, since the number of characters of the text objects having the same attribute as that of each text object in the unit region is instantly acquired on the basis of the attribute information 810, it is possible to calculate the index value V regarding each text object in a relatively short time. Further, it is possible to reduce the search time. Thus, by using the attribute information 810 stored in the server 70 in advance, it is possible to reduce the time for the search performed by the server 70.

Furthermore, though the attribute information 810 has both the color information and the font information herein, this is only one exemplary case. For example, the attribute information 810 may have one of the color information and the font information. Further, the index value V may be calculated on the basis of only one of these information.

### 5. The Fifth Preferred Embodiment

Though the attribute information 810 is generated by the printer driver of the client 30 in the fourth preferred embodiment, this is only one exemplary case. The attribute information 810 may be generated, for example, by another program (e.g., document transmission application) installed in the client 30.

Such an aspect will be shown in the fifth preferred embodiment. The fifth preferred embodiment is a variation of the third and fourth preferred embodiments. Hereinafter, description will be made, centering on the difference between the third and fourth preferred embodiments and the fifth preferred embodiment.

FIG. 31 is a view showing an operation of the fifth preferred embodiment. In the fifth preferred embodiment, the operation shown in FIG. 31 is performed, instead of the operation of FIG. 28.

Additionally to the operation (Steps S11, S13, and S15) of FIG. 28, the document analysis operation (Step S12) is performed by the client 30 in advance (before the search process). The operation of Step S12 is the same as the document analysis operation (Step S54 of FIG. 29) in the fourth preferred embodiment. In the fifth preferred embodiment, however, the document analysis operation (Step S54) is performed by the document transmission application, instead of the printer driver.

In Step S12, the client (document transmission application) 30 analyzes the electronic document generated in Step S11, to thereby generate the attribute information (attribute data) 810 (FIG. 30) on the electronic document.

Further, in Step S13 of the fifth preferred embodiment, the client 30 transmits the information including both the attribute information 810 and the PDL data to the server 70. Then, when the server 70 receives these information (the document data, the attribute information 810, and the like), the server 70 associates these information with each other and stores these information into the storage part 75 (Step S15).

After that, the same search process as that in the fourth preferred embodiment (see FIGS. 7 and 8) is performed. When the search process is performed, the attribute information 810 is used.

Through the above operation, the document analysis operation on the document data (data other than the PDL data herein) is performed by the client 30 in advance and the attribute information regarding the analysis result of the document analysis operation is thereby generated. Then, the server (search apparatus) 70 uses the attribute information 810 to perform the search process. Therefore, like in the fourth preferred embodiment, it is possible to calculate the index value V in a relatively short time. Further, it is possible to reduce the search time.

Further, though the attribute information 810 is transmitted to the server 70 in the fifth preferred embodiment, this is only one exemplary case. The attribute information 810 may be transmitted to an apparatus (file server or the like) under the control of the server 70. The same applies to the fourth preferred embodiment.

### 6. The Sixth Preferred Embodiment

Though the electronic document including the keyword search result is displayed in a unit of one page (see FIG. 26) in Step S25 (FIG. 7) in the above-described preferred embodiments, this is only one exemplary case.

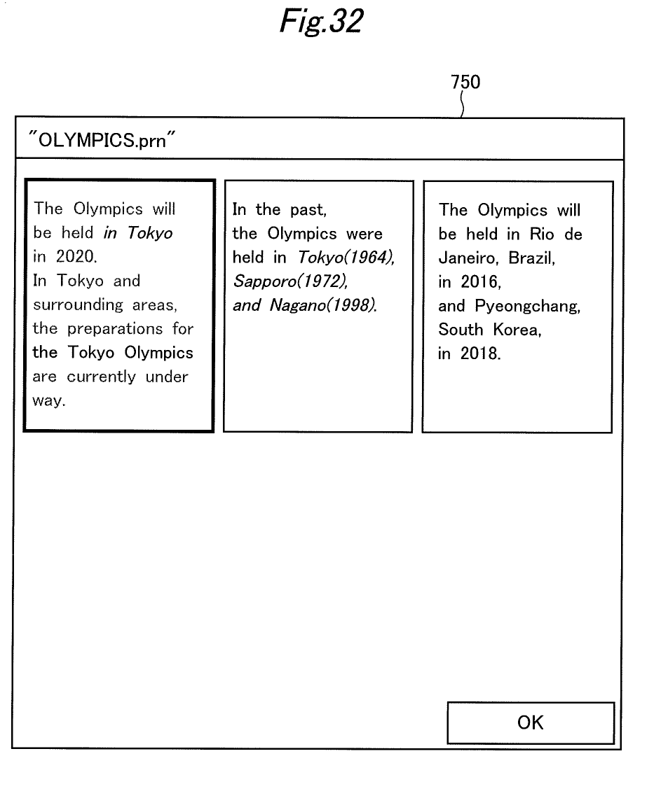

For example, a plurality of pages (particularly, all pages) of an electronic document including the keyword search result may be displayed in a thumbnail view (see FIG. 32).

In more detail, even when the server 70 receives a display instruction for a specific page (display instruction in a unit of a page) like in the first preferred embodiment, in response to the display instruction for the specific page, not only the specific page (one page) but also all the pages including the other pages may be displayed in a thumbnail view.

Alternatively, when the server 70 receives a display instruction for a specific document (display instruction in a unit of a document) like in the second preferred embodiment, in response to the display instruction for the specific document, not only one page in the specific document (the page having the largest index value V) but also all the pages including the other pages may be displayed in a thumbnail view.

By this operation, in the electronic document including the keyword to be searched for, in a case where the description regarding the keyword is present across a plurality of pages, or the like case, it is possible to view the description without turning the pages.

In a case where the electronic document has a large number of pages, or the like case, however, when a large number of pages are displayed in a thumbnail view, the thumbnail image of each page becomes too small and it rather becomes hard to view the thumbnail display.

Then, in the sixth preferred embodiment, description will be made on a technique in which the thumbnail display of all the pages in the electronic document and the image display of one page in the electronic document are (automatically) switched in accordance with whether a predetermined condition C1 is satisfied or not.

Herein, a condition that all the following conditions C11, C12, and C13 are satisfied is exemplarily shown as the condition C1. The conditions C11, C12, and C13 are as follows.

Condition C11: the total number of pages in the document is not larger than a predetermined value TH61 (for example, “6”);

Condition C12: the number of characters per page, with respect to all the pages in the document, is not larger than a predetermined value TH62 (for example, “1000” characters/page); and

Condition C13: a font size of all the text objects in the document, each of which corresponds to the search keyword, is not smaller than a predetermined value TH63 (for example, “10.5” points).

In Step S37 (FIG. 8), the server 70 determines whether the condition C1 is satisfied or not. When the condition C1 is not satisfied, the server 70 generates image data for displaying a thumbnail image of only one specific page in the electronic document. On the other hand, when the condition C1 is satisfied, the server 70 generates image data for displaying thumbnail images of all the pages in the electronic document. Further, in the thumbnail display of all the pages, the page having the largest index value V (for example, the first page (V=85.0)) may be highlighted (surrounded by a thick line, or the like).

Then, the server 70 transmits the generated image data and the like to the client 50 (Step S38), and the client 50 displays the search result list on the display part 56b thereof on the basis of the received image data and the like (Steps S24 and S25).

When the condition C1 is satisfied, the client 50 displays thereon the thumbnail images of all the pages in the electronic document. As shown in FIG. 32, for example, the thumbnail images (three pieces of thumbnail images) of all the pages (herein, three pages) of the electronic document “OLYMPICS.prn” are displayed.

By this operation, in the case where the description regarding the search keyword (particularly, the descriptions regarding the retrieved four keywords) are present across a plurality of pages (three pages) of the electronic document, it is possible to view the descriptions without performing any page turning operation (operation of changing the page to be displayed).

Herein, in the case where the server 70 receives the display instruction of the specific page (the display instruction in a unit of a page) like in the above-described first preferred embodiment, the above-described image generation operation may be performed in response to the display instruction of the specific page (one page).

Further, also in the case where the server 70 receives the display instruction of the specific document (the display instruction in a unit of a document) like in the above-described second preferred embodiment, the same modification may be performed.

For example, first, the server 70 further specifies one page having the largest index value V in the specific document in response to the display instruction of the specific document. Then, the server 70 may switch between the display of only the thumbnail image of the one page and the display of all the thumbnail images of all the pages including the one page, in accordance with whether the predetermined condition C1 is satisfied or not.

Further, though the condition that all the following conditions C11, C12, and C13 are satisfied is exemplarily shown as the condition C1 in the above-described preferred embodiments, this is only one exemplary case. For example, without taking the condition C13 into consideration, a condition that all the two conditions C11 and C12 are satisfied may be adopted as the condition C1.

### 7. The Seventh Preferred Embodiment

The seventh preferred embodiment is a variation of the first preferred embodiment and the like. Hereinafter, description will be made, centering on the difference between the first and seventh preferred embodiments.

Though a text object having a color brightness difference smaller than the threshold value TH1 (also referred to as TH11) is excluded from the search result of the keyword search in the above-described preferred embodiments and the like, this is only one exemplary case.

In the seventh preferred embodiment, instead of the color brightness difference, a color difference is used. Specifically, when the color difference regarding a text object is smaller than a threshold value TH12, the text object is excluded from the search result of the keyword search.

Herein, the color difference is an index value indicating a difference between the color (R1, G1, B1) of the character string of the text object to be evaluated and the color (R2, G2, B2) of the background of the character string. As the color difference, for example, a value (“color difference”) Cd expressed by the following Equation (5), which is proposed by W3C (WORLD WIDE WEB CONSORTIUM), may be used. The value Cd is the sum of differential absolute values for the components R, G, and B of these colors.

Cd=|R1−R2|+|G1−G2|+|B1−B2| (5)

Further, though the color difference is used instead of the color brightness difference herein, this is only one exemplary case, and a contrast ratio may be used.

Specifically, when the contrast ratio regarding a text object is smaller than a threshold value TH13, the text object may be excluded from the search result of the keyword search.

The contrast ratio is an index value indicating a ratio between the relative luminance L of the character string of the text object to be evaluated and the relative luminance L of the background of the character string. As the contrast ratio, for example, a value (“contrast ratio”) Cr expressed by the following Equation (6), which is proposed by W3C (WORLD WIDE WEB CONSORTIUM), may be used.

$$Cr = \frac{L 1 + 0.05}{L 2 + 0.05} \qquad ( 6 )$$

In Eq. 6, the relative luminance L1 is a brighter relative luminance L out of the two relative luminances (the relative luminance L of the character string of the text object to be evaluated and the relative luminance L of the background of the character string), and the other relative luminance (darker relative luminance) L is the relative luminance L2. Further, the relative luminance is a value calculated by using the following Equation (7).

L=0.2126×R0+0.7152×G0+0.0722×B0 (7)

Furthermore, the values R0, G0, and B0 are values calculated by using the following Equations (8) to (10).

$$\begin{matrix}\{ \begin{matrix}R 0 = \frac{\frac{R}{255}}{12.92} ( where \frac{R}{255} \leq 0.03928 ) \\ R 0 = {( \frac{\frac{R}{255} + 0.055}{1.055} )}^{2.4} ( where \frac{R}{255} > 0.03928 )\end{matrix} & ( 8 ) \\ \{ \begin{matrix}G 0 = \frac{\frac{G}{255}}{12.92} ( where \frac{G}{255} \leq 0.03928 ) \\ G 0 = {( \frac{\frac{G}{255} + 0.055}{1.055} )}^{2.4} ( where \frac{G}{255} > 0.03928 )\end{matrix} & ( 9 ) \\ \{ \begin{matrix}B 0 = \frac{\frac{B}{255}}{12.92} ( where \frac{B}{255} \leq 0.03928 ) \\ B 0 = {( \frac{\frac{B}{255} + 0.055}{1.055} )}^{2.4} ( where \frac{B}{255} > 0.03928 )\end{matrix} & ( 10 )\end{matrix}$$

Thus, the search result may be narrowed down, taking the color difference, the contrast ratio, or the like into consideration.

Further, just as the threshold value and the like regarding the color brightness difference is changeable by the user (see FIG. 9), it is preferable that other threshold values (the threshold value regarding the color difference, the threshold value regarding the contrast ratio, and the like) should be changeable by the user.

Furthermore, as to the narrowing-down, though only one condition of the color brightness difference, the color difference, and the contrast ratio may be taken into consideration, this is only one exemplary case and two or more conditions (two conditions or all the three conditions) of the color brightness difference, the color difference, and the contrast ratio may be taken into consideration. In other words, at least one of the color brightness difference, the color difference, and the contrast ratio may be taken into consideration.

### 8. The Eighth Preferred Embodiment

Though the case where the unit region is a “page” has been exemplarily shown in the above-described preferred embodiments, this is only one exemplary case, and for example, the unit region may be an (entire) “document”. Specifically, with a “document” as the unit region, the index value V may be calculated. In detail, by adopting an “(entire) document” as the unit region, the values Z, N1, and N2 in Equations (2) to (4) may be calculated. More specifically, the number of characters of the text objects having the same color attribute as that of the text object to be evaluated in the “document” may be obtained as the value N1. Further, the number of characters of the text objects having the same font attribute as that of the text object to be evaluated in the “document” may be obtained as the value N2. Furthermore, the total number of characters in the “document” including the text object to be evaluated may be obtained as the value Z. Hereinafter, such an aspect will be shown.

The eighth preferred embodiment is a variation of the first preferred embodiment and the like. Hereinafter, description will be made, centering on the difference between the first and eighth preferred embodiments.

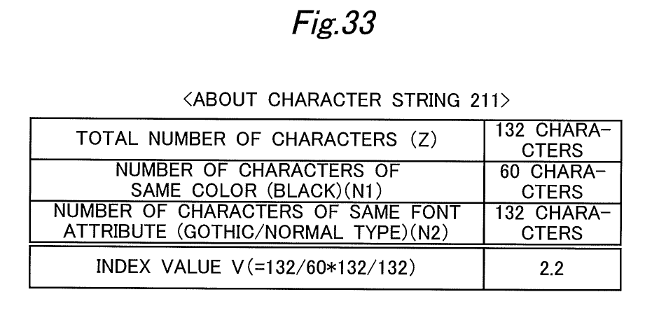

FIG. 33 is a view showing the index value V and the like of the character string 211 when the unit region is an “(entire) document”. FIG. 33 shows that the total number Z of characters in the document D1 is “132” characters. Further, FIG. 33 shows that the number N1 of characters of the character strings having the same color attribute (“black”) as that of the character string 211 in the document D1 is “60” characters, and the number N2 of characters of the character strings having the same font attribute (“Gothic type and normal type”) as that of the character string 211 in the document D1 is “132” characters. Then, FIG. 33 also shows that the index value V is “2.2” (=(132/60)*(132/132)).

Similarly, the respective index values V of the character strings 212 and 213 are each “2.2”.

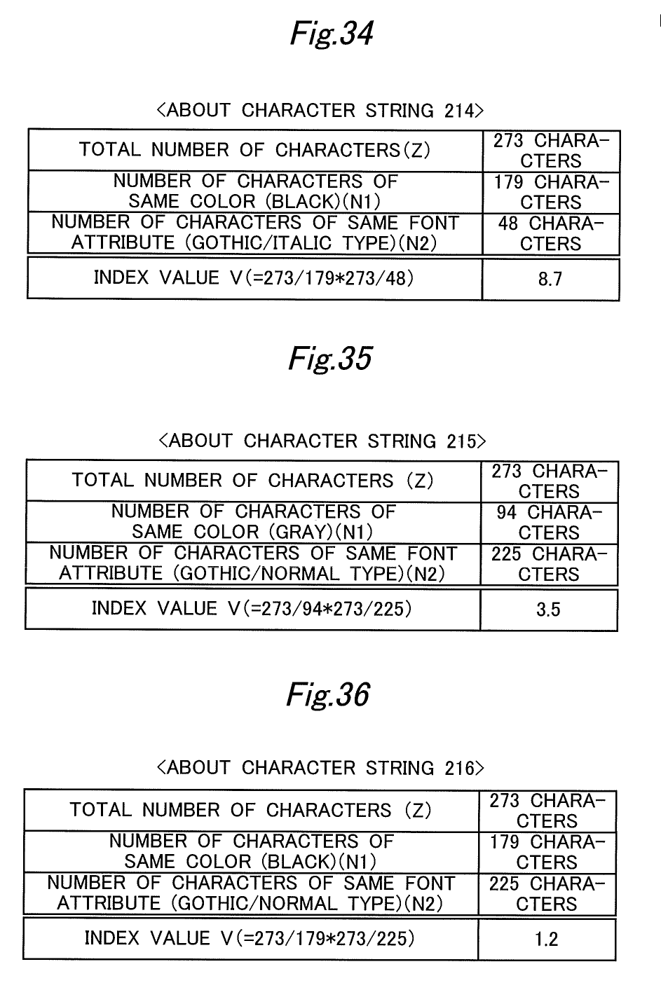

FIG. 34 is a view showing the index value V and the like of the character string 214 when the unit region is an “(entire) document”. FIG. 34 shows that the total number Z of characters in the document D1 is “273” characters. Further, FIG. 34 shows that the number N1 of characters of the character strings having the same color attribute (“black”) as that of the character string 214 in the document D1 is “179” characters, and the number N2 of characters of the character strings having the same font attribute (“Gothic type and italic type”) as that of the character string 214 in the document D1 is “48” characters. Then, FIG. 34 also shows that the index value V is “8.7” (=(273/179)*(273/48)).

FIG. 35 is a view showing the index value V and the like of the character string 215 when the unit region is an “(entire) document”. FIG. 35 also shows that the index value V is “3.5” (=(273/94)*(273/225)).

FIG. 36 is a view showing the index value V and the like of the character string 216 when the unit region is an “(entire) document”. FIG. 36 also shows that the index value V is “1.2” (=(273/179)*(273/225)).

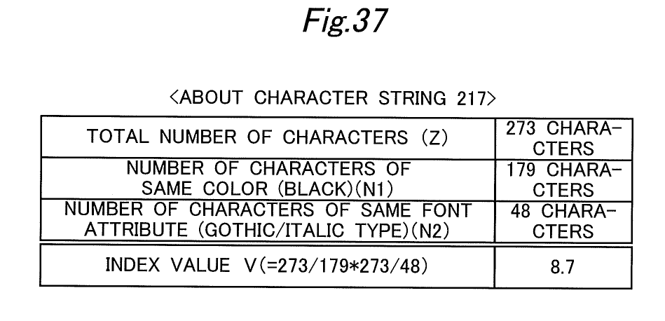

FIG. 37 is a view showing the index value V and the like of the character string 217 when the unit region is an “(entire) document”. FIG. 37 also shows that the index value V is “8.7” (=(273/179)*(273/48)).

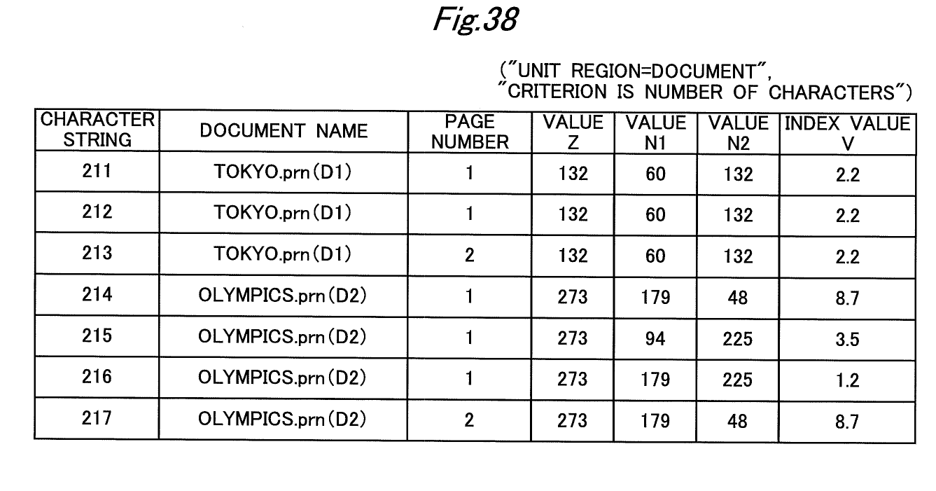

FIG. 38 is a view collectively showing these information. By calculating the degree of significance of each text object on the basis of the index value V thus obtained, it is possible to determine the degree of significance of the text object to be evaluated, with a criterion through the entire document.

After that, on the basis of the index value V of each text object, which is thus calculated, the degree of significance of each page may be calculated, like in the first preferred embodiment. Then, the operation of displaying the search result in which the pages are arranged in descending order of the degree of significance thereof, and the like operation, may be performed.

Further, like in the second preferred embodiment, the degree of significance of each document may be further calculated. Then, the operation of displaying the search result in which the documents are arranged in descending order of the degree of significance thereof, and the like operation, may be performed.

### 9. The Ninth Preferred Embodiment

The ninth preferred embodiment is a variation of the first preferred embodiment and the like. Hereinafter, description will be made, centering on the difference between the first and ninth preferred embodiments.

Though the index value V is calculated on the basis of the “number of characters” in the above-described preferred embodiments, this is only one exemplary case, and the index value V may be calculated on the basis of the “number of words”, instead of the number of characters. Specifically, in the calculation of the index value V (the calculation of the values Z, N1, and N2 in Equations (2) to (4)), the “number of characters” may be replaced with the “number of words”.

In more detail, the “number of words” of the text objects having the same color attribute as that of the text object to be evaluated in the unit region may be obtained as the value N1. Further, the “number of words” of the text objects having the same font attribute as that of the text object to be evaluated in the unit region may be obtained as the value N2. Furthermore, the “total number of words” in the unit region including the text object to be evaluated may be obtained as the value Z. In short, “with the number of words as the criterion”, the values N1, N2, and Z may be obtained.

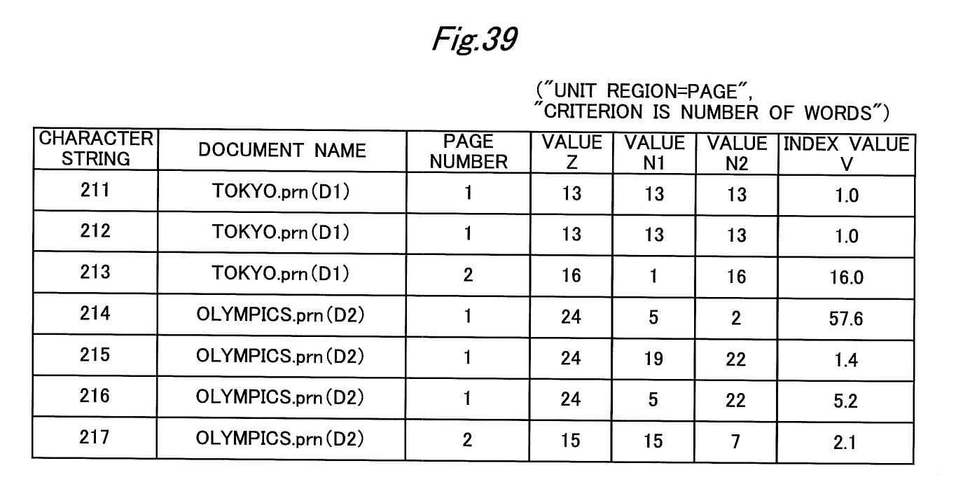

FIG. 39 is a view collectively showing respective values Z, N1, N2, and V of the retrieved seven text objects (character strings 211 to 217). FIG. 39 shows the values Z, N1, N2, and V (with the number of words as the criterion) when a “page” is adopted as the “unit region”.

For example, in the fourth line from the top of FIG. 39, shown is the information on the character string 214. Specifically, the total number of words (“24 words”) of the page (the first page of the electronic document D2 (FIG. 17)) including the character string 214 is acquired as the value Z. Further, the number of words (“5 words”) of the text objects having the same color attribute (“black”) as that of the character string 214 in the unit region (“page”) is acquired as the value N1. Furthermore, the number of words (“2 words”) of the text objects having the same font attribute (“Gothic type and italic type”) as that of the character string 214 in the unit region (“page”) is acquired as the value N2.

Thus, FIG. 39 shows that, with respect to the character string 214, the value Z is “24”, the value N1 is “5”, and the value N2 is “2”.

Further, FIG. 39 shows that the index value V based on the values Z, N1, and N2 is “57.6” (=(24/5)*(24/2)).

Also with respect to the other character strings 211 to 213 and 215 to 217, the respective index values V and the like are shown.

After that, on the basis of the index value V of each text object, which is thus obtained, the degree of significance of each page may be calculated, like in the first preferred embodiment. Then, the operation of displaying the search result in which the pages are arranged in descending order of the degree of significance thereof, and the like operation, may be performed (see the first preferred embodiment).

Further, like in the second preferred embodiment, the degree of significance of each document may be further calculated. Then, the operation of displaying the search result in which the documents are arranged in descending order of the degree of significance thereof, and the like operation, may be performed.

Though the index value V is calculated by adopting a “page” as the “unit region” herein, this is only one exemplary case. For example, also when the index value V is calculated on the basis of the “number of words” instead of the number of characters, the values Z, N1, N2, and V may be calculated by adopting an “(entire) document” as the “unit region”.

### 10. Others

Though the preferred embodiments of the present invention have been described above, the present invention is not limited to the above-described exemplary cases.

Though the keyword search or the like is performed in the plurality of electronic documents transmitted from one client 30 to the server 70 in the above-described preferred embodiments and the like, for example, this is only one exemplary case, and the keyword search or the like may be performed in the plurality of electronic documents transmitted from a plurality of clients 30 and the like to the server 70.

Further, though the keyword search or the like is performed in the plurality of electronic documents in the above-described preferred embodiments and the like, this is only one exemplary case, and the keyword search or the like may be performed only in a single electronic document.

Though the exemplary case where the electronic documents are accumulated in the server 70 has been shown in the above-described preferred embodiments, this is only one exemplary case. The electronic documents may be accumulated in an apparatus (another server or the like) other than the server 70. In more detail, there may be a case where the server (intracompany server) 70 is disposed inside a company and electronic documents are stored (accumulated) in a cloud server, and the intracompany server 70 can thereby perform the above-described search in a plurality of electronic documents stored in the cloud server.

Further, though the text objects satisfying the predetermined condition (the condition regarding the font size, the color brightness difference, and the like) are excluded from the search result in the narrowing-down process in the above-described preferred embodiments and the like, this is only one exemplary case. As to the text objects satisfying the predetermined condition (the condition regarding the font size, the color brightness difference, and the like), for example, instead of being excluded from the search result in the narrowing-down process (Step S33), the degree of significance thereof may be reduced.

In more detail, in a case where the font size of one text object is smaller than the threshold value, the degree of significance of the one text object may be reduced to β times (β<1) (e.g., β=½=0.5) the original value, as compared with another case where the font size is larger than the threshold value. In other words, a value obtained by multiplying the index value V by the value β (obtained by reducing the index value V) may be determined as the degree of significance of the one text object.

Similarly, in a case where a condition that the difference (e.g, at least one of the color brightness difference, the color difference, and the contrast ratio) between one text object and the background thereof is smaller than a predetermined degree is satisfied, the degree of significance of the one text object may be reduced, as compared with another case where the condition is not satisfied (Step S35). In more detail, when the difference is smaller than the corresponding threshold value (TH11, TH12, or TH13), the degree of significance of the one text object may be reduced to β times (β<1) (e.g., β=½) the original value.

Further, in a case where the font size of one text object is smaller than the threshold value and the difference (the color brightness difference or the like) between the one text object and the background thereof is smaller than a predetermined degree, the degree of significance of the one text object may be reduced to a further smaller value (for example, (6×6) times (e.g., one fourth of) the original value).

Furthermore, though the “page delimiter information” is also included in each electronic document in the above-described preferred embodiments and the like, this is only one exemplary case. In a case where the unit region is a “document”, or the like case, the page delimiter information may not be included.

While the invention has been shown and described in detail, the foregoing description is in all aspects illustrative and not restrictive. It is therefore understood that numerous modifications and variations can be devised without departing from the scope of the invention.

What is claimed is:

1. A search apparatus for performing a keyword search in one or more electronic documents, comprising:
a receiving part for receiving a specification input regarding a keyword to be searched for;
a search part for performing a keyword search based on said specification input;
an acquisition part for acquiring an index value based on a contrast between the total number of characters in a unit region including a specific text object retrieved by said keyword search and the number of characters of one or more text objects in said unit region, which have the same attribute as that of said specific text object, said index value indicating the rarity of said attribute of said specific text object; and
a determination part for determining a degree of significance of said specific text object on the basis of said index value.

2. The search apparatus according to claim 1, wherein
said attribute includes a color attribute of one or more text objects, and
said index value is a value based on a contrast between the number of characters of one or more text objects in said unit region, which have the same color attribute as that of said specific text object, and the total number of characters in said unit region.

3. The search apparatus according to claim 1, wherein
said attribute includes a font attribute of one or more text objects, and
said index value is a value based on a contrast between the number of characters of one or more text objects in said unit region, which have the same font attribute as that of said specific text object, and the total number of characters in said unit region.

4. The search apparatus according to claim 1, wherein
said attribute includes a color attribute and a font attribute of one or more text objects, and
said index value is a value based on a contrast between the number of characters of one or more text objects in said unit region, which have the same color attribute as that of said specific text object, and the total number of characters in said unit region and based on a contrast between the number of characters of one or more text objects in said unit region, which have the same font attribute as that of said specific text object, and the total number of characters in said unit region.

5. The search apparatus according to claim 3, wherein
said font attribute is an attribute represented by at least one of a font type and a font style.

6. The search apparatus according to claim 1, wherein
said unit region is a page in an electronic document.

7. The search apparatus according to claim 1, wherein
said unit region is one entire electronic document.

8. The search apparatus according to claim 1, wherein
said acquisition part acquires said index value regarding each specific text object retrieved by said keyword search from said unit region, and
said determination part determines a degree of significance of said each specific text object on the basis of said index value of said each specific text object and determines the degree of significance of an object having the highest degree of significance in said unit region, as a degree of significance of said unit region.

9. The search apparatus according to claim 6, wherein
said acquisition part acquires said index value regarding each specific text object retrieved by said keyword search from one page of each electronic document, and
said determination part determines a degree of significance of said each specific text object on the basis of said index value of said each specific text object and determines the degree of significance of one or more text objects having the highest degree of significance in said one page, as a degree of significance of said one page.

10. The search apparatus according to claim 9, further comprising:
a list generation part for generating a list in which pages each including at least one text object retrieved from said one or more electronic documents by said keyword search are arranged in accordance with the degree of significance of each page.

11. The search apparatus according to claim 10, further comprising:
an image generation part for generating a thumbnail image including a specific page in response to a display instruction when said display instruction of said specific page is given with reference to said list,
wherein said image generation part generates a thumbnail image of only said specific page when a predetermined condition is not satisfied, and
said image generation part generates thumbnail images of all pages in a specific electronic document including said specific page when said predetermined condition is satisfied.

12. The search apparatus according to claim 11, wherein
said predetermined condition is a condition satisfying that
the total number of pages in said specific electronic document including said specific page is not larger than a first value,
the number of characters per page is not larger than a second value with respect to all pages in said specific electronic document, and
a font size of all text objects each of which corresponds to a search keyword in said specific electronic document is not smaller than a third value.

13. The search apparatus according to claim 9, wherein
said acquisition part acquires said index value regarding each specific text object retrieved by said keyword search from each page of a plurality of electronic documents, and
said determination part determines a degree of significance of said each specific text object on the basis of said index value of said each specific text object, and determines the degree of significance of one or more text objects having the highest degree of significance in said each page, as a degree of significance of said each page, and determines the degree of significance of a page having the highest degree of significance in one electronic document, as a degree of significance of said one electronic document.

14. The search apparatus according to claim 13, further comprising:
a list generation part for generating a list in which two or more electronic documents including at least one text object retrieved by said keyword search from said plurality of electronic documents are arranged in accordance with the degrees of significance of two or more electronic documents.

15. The search apparatus according to claim 1, wherein
said search part excludes a text object from a search result of said keyword search when a font size of said text object is smaller than a threshold value.

16. The search apparatus according to claim 1, wherein
said search part excludes a text object from a search result of said keyword search when at least one of a color brightness difference, a color difference, and a contrast ratio between said text object and a background thereof is smaller than a corresponding threshold value.

17. The search apparatus according to claim 1, wherein
said search part reduces a degree of significance of said specific text object when a font size of said specific text object is smaller than a threshold value, as compared with a case where said font size of said specific text object is larger than said threshold value.

18. The search apparatus according to claim 1, wherein
said search part reduces a degree of significance of said specific text object when a condition that at least one of a color brightness difference, a color difference, and a contrast ratio between said specific text object and a background thereof is smaller than a corresponding threshold value is satisfied, as compared with a case where said condition is not satisfied.

19. The search apparatus according to claim 15, wherein
said threshold value is changeable by a user.

20. The search apparatus according to claim 1, wherein
said one or more electronic documents to be searched include an electronic document described by a page description language, as print data.

21. The search apparatus according to claim 1, wherein
said one or more electronic documents to be searched include an electronic document having one or more text objects, page delimiter information, and a color attribute and a font attribute of each specific text object.

22. The search apparatus according to claim 2, further comprising:
a storage part for storing therein attribute information defining the total number of characters in each unit region on each electronic document and the number of characters for each color attribute in said each unit region, which is generated by a generation apparatus for said each electronic document and received in advance from said each generation apparatus,
wherein said acquisition part specifies one color attribute which is the same color attribute as that of said specific text object, and
acquires the total number of characters in said unit region including said specific text object and the number of characters of one or more text objects in said unit region, which have said one color attribute, on the basis of said attribute information, to thereby calculate said index value regarding said specific text object.

23. The search apparatus according to claim 3, further comprising:
a storage part for storing therein attribute information defining the total number of characters in each unit region on each electronic document and the number of characters for each font attribute in said each unit region, which is generated by a generation apparatus for said each electronic document and received in advance from said each generation apparatus,
wherein said acquisition part specifies one font attribute which is the same font attribute as that of said specific text object, and
acquires the total number of characters in said unit region including said specific text object and the number of characters of one or more text objects in said unit region, which have said one font attribute, on the basis of said attribute information, to thereby calculate said index value regarding said specific text object.

24. The search apparatus according to claim 4, further comprising:
a storage part for storing therein attribute information defining the total number of characters in each unit region on each electronic document, the number of characters for each color attribute in said each unit region, and the number of characters for each font attribute in said each unit region, which is generated by a generation apparatus for said each electronic document and received in advance from said each generation apparatus,
wherein said acquisition part specifies one color attribute which is the same color attribute as that of said specific text object and one font attribute which is the same font attribute as that of said specific text object, and
acquires the total number of characters in said unit region including said specific text object, the number of characters of one or more text objects in said unit region, which have said one color attribute, and the number of characters of one or more text objects in said unit region, which have said one font attribute, on the basis of said attribute information, to thereby calculate said index value regarding said specific text object.

25. A non-transitory computer-readable recording medium for recording a computer program to be executed by a computer to cause said computer to perform the steps of:
a) receiving a specification input regarding a keyword to be searched for;
b) performing a keyword search in one or more electronic documents on the basis of said specification input;
c) acquiring an index value based on a contrast between the total number of characters in a unit region including a specific text object retrieved by said keyword search and the number of characters of one or more text objects in said unit region, which have the same attribute as that of said specific text object, said index value indicating the rarity of said attribute of said specific text object; and
d) determining a degree of significance of said specific text object on the basis of said index value.

26. A non-transitory computer-readable recording medium for recording a computer program to be executed by a computer to cause said computer to perform the steps of:
a) generating attribute information defining the total number of characters in a unit region in an electronic document and the number of characters for each attribute in said unit region; and
b) transmitting said attribute information to a search apparatus for performing a keyword search or an apparatus under the control of said search apparatus.

27. A non-transitory computer-readable recording medium for recording a computer program to be executed by a computer to cause said computer to perform the steps of:
a) receiving attribute information defining the total number of characters in a unit region in each electronic document and the number of characters for each attribute in said unit region from a generation apparatus for said each electronic document;
b) receiving a specification input regarding a keyword to be searched for;
c) performing a keyword search in said each electronic document on the basis of said specification input;
d) specifying one attribute which is the same attribute as that of a specific text object retrieved by said keyword search;
e) calculating an index value based on a contrast between the total number of characters in a unit region including said specific text object and the number of characters of one or more text objects in said unit region, which have said one attribute, said index value indicating the rarity of said attribute of said specific text object, on the basis of said attribute information; and
f) determining a degree of significance of said specific text object on the basis of said index value.

28. A search apparatus for performing a keyword search in one or more electronic documents, comprising:
a receiving part for receiving a specification input regarding a keyword to be searched for;
a search part for performing a keyword search based on said specification input;
an acquisition part for acquiring an index value based on a contrast between the total number of words in a unit region including a specific text object retrieved by said keyword search and the number of words of one or more text objects in said unit region, which have the same attribute as that of said specific text object, said index value indicating the rarity of said attribute of said specific text object; and
a determination part for determining a degree of significance of said specific text object on the basis of said index value.

29. A non-transitory computer-readable recording medium for recording a computer program to be executed by a computer to cause said computer to perform the steps of;
a) receiving a specification input regarding a keyword to be searched for;
b) performing a keyword search in one or more electronic documents on the basis of said specification input;
c) acquiring an index value based on a contrast between the total number of words in a unit region including a specific text object retrieved by said keyword search and the number of words of one or more text objects in said unit region, which have the same attribute as that of said specific text object, said index value indicating the rarity of said attribute of said specific text object; and
d) determining a degree of significance of said specific text object on the basis of said index value.
